(19) United States
(12) Patent Application Publication
(10) Pub. No.: US 2025/0247002 A1
(43) Pub. Date: Jul. 31, 2025

(54) CONTROL DEVICE, SWITCHING POWER SUPPLY CIRCUIT, AND CONTROL METHOD

(71) Applicant: TDK Corporation, Tokyo (JP)

(72) Inventors: Tsuyoshi MANO, Tokyo (JP); Kazutoyo Fukunaga, Tokyo (JP)

(73) Assignee: TDK Corporation, Tokyo (JP)

(21) Appl. No.: 18/999,379

(22) Filed: Dec. 23, 2024

(30) Foreign Application Priority Data
Jan. 31, 2024 (JP) 2024-012521

(51) Int. Cl. H02M 3/158; H02M 1/14

(52) U.S. Cl. CPC H02M 3/158; H02M 1/14

(57) ABSTRACT

A control device controlling a switching power supply circuit including first switching element and second switching element, wherein control device operates switching power supply circuit in accordance with operation mode according to difference between voltage value of input or of output voltage supply circuit, control device linearly changes duty ratio in PWM (Pulse Width Modulation) control of first switching element from first start point, and linearly changes duty ratio in PWM control of second switching element from second start point, in case in which operation mode operating switching power supply circuit is to be switched, first start point or the second start point are duty ratio in PWM control of first or second switching element before operation mode switching set as start point or second start point at which duty ratio in PWM control of first switching element or the second switching element after operation mode switching to be changed.

### BACKGROUND OF THE INVENTION

### Field of the Invention

The present disclosure relates to a control device, a switching power supply circuit, and a control method.

Priority is claimed on Japanese Patent Application No. 2024-012521, filed Jan. 31, 2024, the content of which is incorporated herein by reference.

### Description of Related Art

Technologies relating to step up/down-type switching power supply circuits capable of outputting an output voltage of an intended magnitude without depending on the magnitude of an input voltage have been researched and developed.

In relation to this, a switching power supply circuit including a first switching means formed from a plurality of switching elements used for controlling a conduction state of an input side, a second switching means formed from a plurality of switching elements used for controlling a conduction state of an output side, a feedback pulse generating means generating a feedback pulse with a pulse width corresponding to an output electric potential, a first control means that switches between a plurality of operation modes including at least a step-down mode and a step-up mode in accordance with an input electric potential, gives a feedback pulse to the first switching means in the step-down mode, and gives a feedback pulse to the second switching means in the step-up mode, and a second control means that performs control of the feedback pulse generating means such that a duty ratio of the feedback pulse is constant without depending on a plurality of operation modes is known.

### PATENT DOCUMENTS

[Patent Document 1] Japanese Unexamined Patent Application, First Publication No. 2005-318662

### SUMMARY OF THE INVENTION

Here, in a switching power supply circuit as described in Patent Document 1, ripples may be generated in the input voltage at the time of switching between operation modes. This leads to an application of a load to a circuit element of the switching power supply circuit, which is not desirable.

The present disclosure is in view of such situations, and an object thereof is to provide a control device, a switching power supply circuit, and a control method capable of inhibiting generation of ripples in an input voltage at the time of switching between operation modes of a switching power supply circuit.

According to one aspect of the present disclosure, there is provided a control device controlling a switching power supply circuit comprising a first switching element and a second switching element, wherein the control device operates the switching power supply circuit in accordance with an operation mode according to a difference between a voltage value of an input voltage for the switching power supply circuit and a voltage value of an output voltage from the switching power supply circuit, the control device linearly changes a duty ratio in PWM (Pulse Width Modulation) control of the first switching element from a first start point, and linearly changes a duty ratio in PWM control of the second switching element from a second start point, in a case in which the operation mode operating the switching power supply circuit is to be switched, the first start point is a duty ratio in PWM control of the first switching element before the operation mode switching set as a start point at which a duty ratio in PWM control of the first switching element after the operation mode switching to be changed, the second start point is a duty ratio in PWM control of the second switching element before the operation mode switching set as the second start point at which a duty ratio in PWM control of the second switching element after the operation mode switching starts to be changed.

In addition, according to another aspect of the present disclosure, there is provided a switching power supply circuit comprising a first switching element and a second switching element, wherein the switching power supply circuit is operated in accordance with an operation mode according to a difference between a voltage value of an input voltage for the switching power supply circuit and a voltage value of an output voltage from the switching power supply circuit, the switching power supply circuit linearly changes a duty ratio in PWM (Pulse Width Modulation) control of the first switching element from a first start point, and linearly changes a duty ratio in PWM control of the second switching element from a second start point, in a case in which the operation mode operating the switching power supply circuit is to be switched, the first start point is a duty ratio in PWM control of the first switching element before the operation mode switching set as a start point at which a duty ratio in PWM control of the first switching element after the operation mode switching to be changed, the second start point is a duty ratio in PWM control of the second switching element before the operation mode switching set as the second start point at which a duty ratio in PWM control of the second switching element after the operation mode switching starts to be changed.

In addition, according to another aspect of the present disclosure, there is provided a control method controlling a switching power supply circuit including a first switching element and a second switching element, the control method comprising: operating the switching power supply circuit in accordance with an operation mode according to a difference between a voltage value of an input voltage for the switching power supply circuit and a voltage value of an output voltage from the switching power supply circuit; and linearly changing a duty ratio in PWM (Pulse Width Modulation) control of the first switching element from a first start point, and linearly changing a duty ratio in PWM control of the second switching element from a second start point, in a case in which the operation mode operating the switching power supply circuit is to be switched, the first start point is a duty ratio in PWM control of the first switching element before the operation mode switching set as a start point at which a duty ratio in PWM control of the first switching element after the operation mode switching to be changed, the second start point is a duty ratio in PWM control of the second switching element before the operation mode switching set as the second start point at which a duty ratio in PWM control of the second switching element after the operation mode switching starts to be changed.

According to the present disclosure, generation of ripples in an input voltage at the time of switching between operation modes of a switching power supply circuit can be inhibited.

### BRIEF DESCRIPTION OF THE DRAWINGS

FIG. 1 is a diagram illustrating one example of the configuration of a switching power supply device 1 according to an embodiment.

FIG. 2 is a diagram explaining a method for changing a duty ratio at the time of operation mode switching using a control device 20.

FIG. 3 is a diagram explaining changes of an input voltage value over time in a case in which a duty ratio is nonlinearly changed at the time of operation mode switching.

FIG. 4 is a diagram illustrating one example of the configuration of the control device 20.

FIG. 5 is a diagram illustrating one example of the flow of a process performed by an operation mode determining unit 21.

FIG. 6 is a diagram illustrating one example of a block diagram illustrating feedback control performed by a feedback control unit 22.

FIG. 7 is a diagram illustrating one example of the flow of a process of the feedback control unit 22 performing the I control.

FIG. 8 is a diagram illustrating one example of the flow of a process performed by a range determining unit 231.

FIG. 9 is a diagram illustrating one example of the flow of a process performed by a counter unit 232.

FIG. 10 is a diagram illustrating a configuration example of each of a first comparison unit 25 and a second comparison unit 26 that output a PWM signal based on a carrier signal generated by a carrier signal generating unit 24.

FIG. 11 is a diagram illustrating one example of the flow of a process performed by a signal switching unit 27.

FIG. 12 is a diagram illustrating Modified Example 1 of the configuration of the control device 20.

FIG. 13 is a diagram illustrating one example of changes of each of a first comparative value and a second comparative value over time in a case in which an input voltage value changes over time as illustrated in FIG. 2.

FIG. 14 is a diagram illustrating one example of the flow of a process of the operation mode determining unit 21 determining an operation mode using seven values x1 to x4 and y1 to y3 represented in FIG. 13.

FIG. 15 is a diagram illustrating Modified Example 2 of the configuration of the control device 20.

FIG. 16 is a diagram illustrating a modified example of the flow of a process performed by a signal switching unit 27.

FIG. 17 is a diagram explaining the operation mode determining unit 21 changing each of an upper-limit voltage value z1 and a lower-limit voltage value z2.

FIG. 18 is a diagram illustrating one example of the flow of a process of the operation mode determining unit 21 changing an upper-limit voltage value and a lower-limit voltage value.

### DETAILED DESCRIPTION OF THE INVENTION

### Embodiment

Hereinafter, an embodiment of the present disclosure will be described with reference to the drawings. Here, in the embodiment, a conductor transmitting an electric signal corresponding to a DC power or an electric signal corresponding to an AC power will be referred to as a transmission path in description. The transmission path, for example, may be a conductor printed on a board, a wire in which a conductor is formed in a linear shape, or any other conductor. In the embodiment, a voltage represents an electric potential difference from a predetermined reference electric potential, and illustration and description of the reference electric potential will be omitted. Here, the reference electric potential may be any electric potential. In the embodiment, as one example, a case in which the reference electric potential is the ground electric potential will be described. In this embodiment, the magnitude of a certain voltage will be referred to as the voltage value in description. In this case, for example, the magnitude of an input voltage to be described below will be referred to as the input voltage value.

### <Configuration of Switching Power Supply Device>

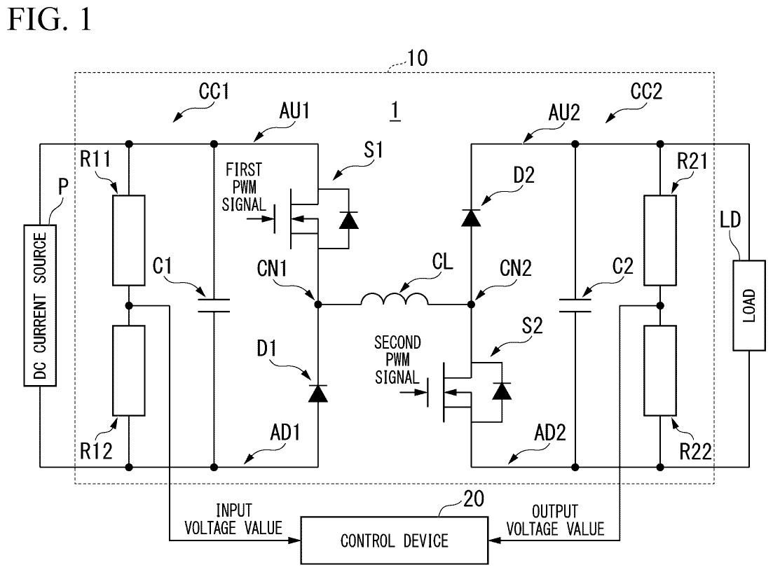

Hereinafter, the configuration of a switching power supply device 1 according to an embodiment will be described with reference to FIG. 1. FIG. 1 is a diagram illustrating one example of the configuration of the switching power supply device 1 according to an embodiment.

The switching power supply device 1 is a device that is controlled such that a DC current is input from a connected power supply, and a DC voltage having an arbitrary voltage value that is determined in advance is supplied as an input voltage. In addition, the switching power supply device 1 is a device that outputs an output voltage according to a connected load in correspondence with a supplied input voltage. Hereinafter, for the convenience of description, the input voltage supplied to the switching power supply device 1 in this way will be simply referred to as an input voltage in description. Hereinafter, for the convenience of description, an output voltage output from the switching power supply device 1 in accordance with this load will be simply referred to as an output voltage in description. The switching power supply device 1 includes at least two switching elements. Hereinafter, as one example, a case in which the switching power supply device 1 includes two switching elements including a first switching element S1 and a second switching element S2 will be described.

The switching power supply device 1 includes a switching power supply circuit 10 and a control device 20. In the switching power supply device 1, as illustrated in FIG. 1, the control device 20 may be configured as a unit that is separate from the switching power supply circuit 10 or may be configured integrally with the switching power supply circuit 10.

The switching power supply circuit 10 includes a first side CC1 including a first upper arm AU1 and a first lower arm AD1 of an H bridge and a second side CC2 including a second upper arm AU2 and a second lower arm AD2 of the H bridge. In addition, the switching power supply circuit 10 includes a coil CL that joins a first connection point CN1 between the first upper arm AU1 and the first lower arm AD1 of the first side CC1 and a second connection point CN2 between the second upper arm AU2 and the second lower arm AD2 of the second side CC2 through a transmission path. Furthermore, the switching power supply circuit 10 includes a first switching element S1 disposed in the first upper arm AU1. In addition, the switching power supply circuit 10 includes a first current limiting unit D1 that is disposed in the first lower arm AD1 and limits a direction of a current from the first lower arm AD1 side to the first upper arm AU1 side. Furthermore, the switching power supply circuit 10 includes a second current limiting unit D2 that is disposed in the second upper arm AU2 and limits a direction of a current from the second lower arm AD2 side to the second upper arm AU2 side. In addition, the switching power supply circuit 10 includes a second switching element S2 disposed in the second lower arm AD2. Furthermore, the switching power supply circuit 10 includes a resistance element R11 and a resistance element R12 that are connected in series between the first upper arm AU1 and the first lower arm AD1, a capacitor C1 connected between the first upper arm AU1 and the first lower arm AD1, a resistance element R21 and a resistance element R22 connected in series between the second upper arm AU2 and the second lower arm AD2, and a capacitor C2 connected between the second upper arm AU2 and the second lower arm AD2. Between the first upper arm AU1 and the first lower arm AD1, the resistance element R11 and the resistance element R12 connected in series are connected in parallel with the capacitor C1. In addition, between the second upper arm AU2 and the second lower arm AD2, the resistance element R21 and the resistance element R22 connected in series are connected in parallel with the capacitor C2. Furthermore, the switching power supply circuit 10 may be configured to further include other elements, other members, other devices, and the like as long as they do not impair the function of the switching power supply circuit 10 described in the embodiment. In addition, the switching power supply circuit 10 may be configured using another bridge in place of the H bridge as long as it does not impair the function of the switching power supply circuit 10 described in the embodiment. In this case, the number of switching elements included in the switching power supply circuit 10 may have any value as long as it is two or more.

In addition, as illustrated in FIG. 1, the switching power supply circuit 10 is connected to each of a DC power supply P that is one example of the power supply described above and a load LD that is one example of the load described above.

The DC power supply P may be any power supply as long as it is a power supply that can input a DC current to the switching power supply circuit Ae DC power supply P is, for example, a solar panel, a DC power supply obtained by rectifying and smoothing a commercial power supply, a secondary battery, a switching power supply, or the like. This switching power supply, for example, is a switching converter or the like. Hereinafter, as one example, a case in which the DC power supply P is a solar panel will be described. The DC power supply P is connected between the first upper arm AU1 and the first lower arm AD1 and applies a DC voltage between the first upper arm AU1 and the first lower arm AD1 as an input voltage. In accordance with this, the DC power supply P supplies (inputs) an input voltage to the switching power supply circuit 10. Hereinafter, as one example, a case in which the DC power supply P applies a DC voltage between the first upper arm AU1 and the first lower arm AD1 as an input voltage with the first upper arm AU1 set as an arm of a high potential side on the first side CC1 and the first lower arm AD1 set as an arm of a low potential side on the first side CC1 (that is, in this example, an arm of the ground electric potential side) will be described. In the example illustrated in FIG. 1, although the DC power supply P is separate from the switching power supply circuit 10, it may be configured integrally with the switching power supply circuit 10.

In addition, the DC power supply P inputs a DC current to the switching power supply circuit 10 as a DC current source. A DC current (DC power) input to the switching power supply circuit 10 is controlled to have an input voltage having an input voltage value that is a target by the control device 20. As a result of such control performed using the control device Be DC power supply P supplies an input voltage to the switching power supply circuit 10. Hereinafter, for the convenience of description, an input voltage value that is a target, that is, a target value of an input voltage value will be simply referred to as a target value in description. Here, input of a target value to the control device 20 may be performed using input of information representing a target value from an external device, may be performed using input of a reference voltage inside the control device 20, or may be performed using any other method.

The load LD, for example, is a rechargeable secondary battery. As the secondary battery, for example, a lithium-ion battery, a lithium polymer battery, or the like may be used. In addition, the load LD may be another device (for example, a motor or the like) performing an operation according to a DC voltage in place of a secondary battery. The load LD is detachably connected between the second upper arm AU2 and the second lower arm AD2, and a DC voltage supplied between the second upper arm AU2 and the second lower arm AD2 is supplied as an output voltage. Hereinafter, as one example, a case in which the switching power supply circuit 10 applies a DC voltage between the second upper arm AU2 and the second lower arm AD2 as an output voltage with the second upper arm AU2 set as an arm of a high potential side on the second side CC2 and the second lower arm AD2 set as an arm of a lower potential side (in other words, in this example, an arm of the ground potential side) on the second side CC2 will be described. In accordance with this, the switching power supply circuit 10 outputs an output voltage. In the example illustrated in FIG. 1, although the load LD is separate from the switching power supply circuit 10, it may be configured integrally with the switching power supply circuit 10. In addition, the load LD may be configured to be detachably connected between the second upper arm AU2 and the second lower arm AD2.

The first switching element S1, for example, is a field effect transistor. In addition, the first switching element S1 may be another switching element such as a bipolar transistor in place of the field effect transistor.

The first current limiting unit D1, for example, is a diode. In this case, the anode of the first current limiting unit D1 is connected to the first lower arm AD1 through a transmission path. In this case, the cathode of the first current limiting unit D1 is connected to the first upper arm AU1 through a transmission path. In addition, the first current limiting unit D1 may be a switching element such as a field effect transistor in place of the diode and may be another element that can limit a direction of a current from the first lower arm AD1 side to the first upper arm AU1 side.

The second switching element S2, for example, is a field effect transistor. In addition, the second switching element S2 may be another switching element such as a bipolar transistor in place of the field effect transistor.

The second current limiting unit D2, for example, is a diode. In this case, the anode of the second current limiting unit D2 is connected to the second lower arm AD2 through a transmission path. In this case, the cathode of the second current limiting unit D2 is connected to the second upper arm AU2 through a transmission path. In addition, the second current limiting unit D2 may be a switching element such as a field effect transistor in place of the diode and may be another element that can limit a direction of a current from the second lower arm AD2 side to the second upper arm AU2 side.

In accordance with the configuration described above, in a case in which an input voltage is input between the first upper arm AU1 and the first lower arm AD1, the switching power supply circuit 10 outputs an output voltage between the second upper arm AU2 and the second lower arm AD2. In addition, in a case in which each of the first current limiting unit D1 and the second current limiting unit D2 is a switching element, the switching power supply circuit 10 may be configured to output an output voltage between the first upper arm AU1 and the first lower arm AD1 in accordance with input of an input voltage between the second upper arm AU2 and the second lower arm AD2. Here, in a case in which each of the first current limiting unit D1 and the second current limiting unit D2 is a diode, the switching power supply circuit 10 can inhibit an increase in the manufacturing cost. This is desirable in a case in which mass production of the switching power supply circuits 10 is performed.

In accordance with the first switching element S1 and the second switching element S2 being controlled by the control device Be switching power supply circuit 10 can operate in each of three operation modes including a step-up mode, a step-up/down mode, and a step-down mode. The step-up mode is an operation mode in which the input voltage is raised for an output voltage. The step-up/down mode is an operation mode in which the input voltage is maintained for an output voltage. The step-down mode is an operation mode in which the input voltage is lowered for an output voltage. A method of controlling the first switching element S1 and the second switching element S2 according to these three operation modes in the switching power supply circuit 10 is a known method, and thus description thereof will be omitted in the embodiment. Hereinafter, for the convenience of description, the operation mode of the switching power supply circuit 10 will be simply referred to as an operation mode in description.

The control device 20 detects an input voltage value and an output voltage value and controls the switching power supply circuit 10 based on the input voltage value and the output voltage value that have been detected. In the example illustrated in FIG. 1, the control device 20 detects a voltage value of the voltage of the connection point between the resistance element R11 and the resistance element R12 as an input voltage value and detects a voltage value of the voltage of the connection point between the resistance element R21 and the resistance element R22 as an output voltage value. In addition, methods of detecting an input voltage value and an output voltage value using the control device 20 may be different from each other. In addition, the function for detecting at least one of the input voltage value and the output voltage value may be included in the switching power supply circuit 10 instead of the control device 20. Hereinafter, for the convenience of description, the function for detecting an input voltage value will be referred to as an input voltage detecting unit, and the function for detecting an output voltage value will be referred to as an output voltage detecting unit.

By switching the operation mode in accordance with a difference between the input voltage value and the output voltage value that have been detected, the control device 20 operates the switching power supply circuit 10 as a constant voltage output source. In a case in which the operation mode is to be switched, the control device 20 specifies a duty ratio in PWM (Pulse Width Modulation) control of the first switching element S1 before operation mode switching as a first start point at which the duty ratio in PWM control of the first switching element S1 after operation mode switching is caused to start to change and specifies a duty ratio in PWM control of the second switching element S2 before operation mode switching as a second start point at which the duty ratio in PWM control of the second switching element S2 after operation mode switching is caused to start to change. Then, the control device 20 linearly changes the duty ratio in the PWM control of the first switching element S1 after operation mode switching from the specified first start point and linearly changes the duty ratio in the PWM control of the second switching element S2 after operation mode switching from the second start point. In accordance with this, the control device 20 can inhibit the duty ratio in the PWM control of the first switching element S1 from discontinuously changing at the time of switching of the operation mode and inhibit the duty ratio in the PWM control of the second switching element S2 from discontinuously changing at the time of switching of the operation mode. As a result, the control device 20 can inhibit generation of ripples in an input voltage at the time of switching of the operation mode. Hereinafter, for the convenience of description, a PWM signal input to a gate terminal of the first switching element S1 will be referred to as a first PWM signal in description. In addition, hereinafter, for the convenience of description, inputting of the first PWM signal to the gate terminal of the first switching element S1 will be referred to as inputting of the first PWM signal to the first switching element S1 in description. Hereinafter, for the convenience of description, a PWM signal input to a gate terminal of the second switching element S2 will be referred to as a second PWM signal in description. In addition, hereinafter, for the convenience of description, inputting of the second PWM signal to the gate terminal of the second switching element S2 will be referred to as inputting of the second PWM signal to the second switching element S2 in description. Hereinafter, for the convenience of description, the duty ratio in the PWM control of the first switching element S1 (that is, the duty ratio of the first PWM signal) will be referred to as a first duty ratio in description. In addition, hereinafter, for the convenience of description, the duty ratio in the PWM control of the second switching element S2 (that is, the duty ratio of the second PWM signal) will be referred to as a second duty ratio in description.

### <Method for Changing Duty Ratio Using Control Device at Time of Operation Mode Switching>

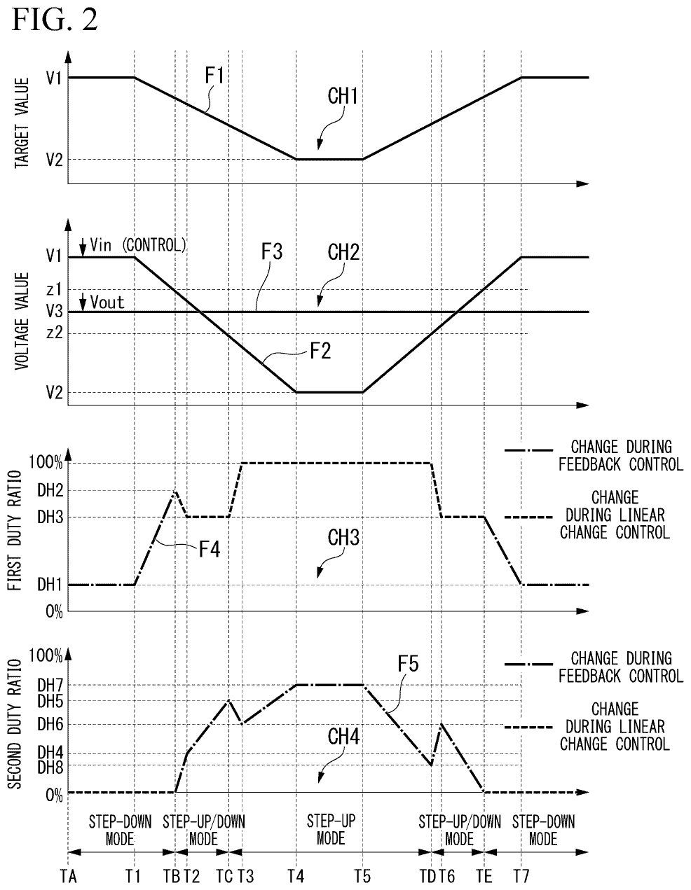

Hereinafter, a method for changing a duty ratio at the time of operation mode switching using the control device 20 will be described with reference to FIG. 2. FIG. 2 is a diagram explaining a method for changing a duty ratio at the time of operation mode switching using the control device 20.

In FIG. 2, four timing charts including timing charts CH1 to CH4 are illustrated. The horizontal axes of these four timing charts have origins coinciding with each other and represent elapsed times from the origins.

The timing chart CH1 is a timing chart that illustrates one example of changes of a target value over time. The timing chart CH2 is a timing chart that illustrates one example of changes of each of an input voltage value and an output voltage value over time. The timing chart CH3 is a timing chart that illustrates one example of changes of the first duty ratio over time. The timing chart CH4 is a timing chart that illustrates one example of changes of the second duty ratio over time.

In the example illustrated in FIG. 2, as illustrated in the timing chart CH1, the control device 20 changes a target value. A curve F1 drawn in the timing chart CH1 illustrates one example of changes of the target value over time. For this reason, in the timing chart CH1, a vertical axis represents the target value. The changes of the target value over time illustrated in FIG. 2 are changes that are experimentally given by a user operating the control device 20 such that changes of the first duty ratio and the second duty ratio over time are clearly indicated. For this reason, the control device 20 does not change the target value as represented by the curve F1 at the time of normal use of the switching power supply circuit 10.

In the example illustrated in FIG. 2, the target value is maintained to be constant with a voltage value V1 within a period of a timing TA to a timing T1. In this example, the target value linearly falls from the voltage value V1 to a voltage value V2 lower than the voltage value V1 within a period of the timing T1 to a timing T4. In addition, in this example, the target value is maintained to be constant with the voltage value V2 within a period of the timing T4 to a timing T5. In this example, the target value linearly rises from the voltage value V2 to the voltage value V1 within a period of the timing T5 to a timing T7. Then, in this example, the target value is maintained to be constant with the voltage value V1 in a period after the timing T7.

Hereinafter, as one example, a case in which the voltage value V1 illustrated in FIG. 2 is an upper limit value of the target value that can be input to the switching power supply circuit 10, and the voltage value V2 is a lower limit value of the target value that can be input to the switching power supply circuit 10 will be described. In other words, hereinafter, as one example, a case in which the voltage value V1 is an upper limit value of the voltage value of the input voltage that can be input to the switching power supply circuit 10, and the voltage value V2 is a lower limit value of the voltage value of the input voltage that can be input to the switching power supply circuit 10 will be described.

As illustrated in the timing chart CH1, in a case in which the target value is changed, as illustrated in the timing chart CH2, the control device 20 changes the input voltage value. A curve F2 drawn in the timing chart CH2 illustrated in FIG. 2 illustrates one example of changes of the input voltage value over time. For this reason, in the timing chart CH2, the vertical axis represents a voltage value.

In the example illustrated in FIG. 2, the input voltage value is changed to follow a target value and thus is maintained to be constant with the voltage value V1 within a period of a timing TA to the timing T1. In addition, in this example, the input voltage value linearly falls from the voltage value V1 to the voltage value V2 within a period of the timing T1 to the timing T4. In this example, the input voltage value is maintained to be constant with the voltage value V2 within a period of the timing T4 to the timing T5. In addition, in this example, the input voltage value linearly rises from the voltage value V2 to the voltage value V1 within a period of the timing T5 to the timing T7. Then, in this example, the input voltage value is maintained to be constant with the voltage value V1 in a period after the timing T7.

Here, an actual output voltage value randomly or periodically changes of accordance with remaining electric charge of a battery that is a load LD, noise, a state of the load, and the like. However, hereinafter, for the convenience of description, as one example, as illustrated using a straight line F3 drawn in the timing chart CH2, a case in which an output voltage having a voltage value V3 determined in advance is constantly output by the switching power supply circuit 10 will be described. Hereinafter, as one example, a case in which the voltage value V3 is a voltage value that is smaller than the voltage value V1 and larger than the voltage value V2 will be described. Here, the straight line F3 illustrates one example of changes of the output voltage value over time.

As illustrated in FIG. 2, in a case in which the input voltage value is changed, the control device 20 sequentially changes the operation mode to the step-down mode, the step-up/down mode, the step-up mode, the step-up/down mode, and the step-down mode in accordance with elapse of time. In accordance with this, the control device 20 is caused to operate as an input voltage control device that maintains the input voltage value input to the switching power supply circuit 10 to be constant for the target value.

In a case in which the operation mode is the step-down mode, the control device 20 changes the first duty ratio through feedback control and changes the second duty ratio through linear change control. Here, in the embodiment, the changing of a certain duty ratio through linear change control represents linearly changing of this duty ratio, that is, changing of this duty ratio with a change rate determined in advance. However, in the linear change control of this duty ratio, in a case in which the duty ratio is raised to the upper limit value of the duty ratio, in the linear change control of the duty ratio, the duty ratio is maintained to be the upper limit value. In addition, in the linear change control of this duty ratio, in a case in which the duty ratio is lowered to the lower limit value of the duty ratio, in the linear change control of the duty ratio, the duty ratio is maintained to be the lower limit value. Hereinafter, for the convenience of description, this change ratio determined in advance will be simply referred to as a predetermined change ratio in description. On the other hand, in a case in which the operation mode is the step-up/down mode or the step-up mode, the control device 20 changes the first duty ratio through linear change control and changes the second duty ratio through feedback control.

Here, in the embodiment, in a case in which the input voltage value is higher than an upper-limit voltage value z1 determined in advance, the switching power supply circuit 10 is controlled to operate in the step-down mode by the control device Be upper-limit voltage value z1 is a threshold determined in accordance with an output voltage value and, for example, is a voltage value acquired by adding 10% of the output voltage value to the output voltage value but is not limited thereto. In this embodiment, in a case in which the input voltage value is lower than a lower-limit voltage value z2 determined in advance, the switching power supply circuit 10 is controlled to operate in the step-up mode by the control device Be lower-limit voltage value z2 is a threshold determined in accordance with an output voltage value and, for example, is a voltage value acquired by subtracting 10% of the output voltage value from the output voltage value but is not limited thereto. In the embodiment, in a case in which the input voltage value is the upper-limit voltage value z1 or less, and the input voltage value is the lower-limit voltage value z2 or more, the switching power supply circuit 10 is controlled to operate in the step-up/down mode by the control device 20. In addition, both the upper-limit voltage value z1 and the lower-limit voltage value z2 may coincide with the output voltage value. In this case, the switching power supply circuit 10 is controlled in accordance with any one of two operation modes including the step-up mode and the step-down mode. In addition, the control device 20 may be configured to perform switching of the operation mode of the switching power supply circuit 10 using another method based on an input voltage value and an output voltage value. In FIG. 2, the magnitude relation of the voltage value V1, the voltage value V2, the upper-limit voltage value z1, the lower-limit voltage value z2, and the output voltage value V3 is “the voltage value V1>the upper-limit voltage value z1>the output voltage value V3>the lower-limit voltage value z2>the voltage value V2.”

In a case in which the control device 20 changes the input voltage value as illustrated in the timing chart CH2, the control device 20 changes the first duty ratio as illustrated in the timing chart CH3, and changes the second duty ratio as illustrated in the timing chart CH4. Here, a curve F4 illustrated in the timing chart CH3 illustrates one example of changes of the first duty ratio over time. For this reason, in the timing chart CH3, the vertical axis represents a duty ratio. In addition, in the timing chart CH3, a part of the curve F4 that represents changes of the first duty ratio over time through feedback control is differentiated from a part of the curve F4 that represents changes of the first duty ratio over time through linear change control in accordance with a line type. On the other hand, a curve F5 illustrated in the timing chart CH4 illustrates one example of changes of the second duty ratio over time. For this reason, in the timing chart CH4, the vertical axis represents a duty ratio. In addition, in the timing chart CH4, a part of the curve F5 that represents changes of the second duty ratio over time through feedback control is differentiated from a part of the curve F5 that represents changes of the second duty ratio over time through linear change control in accordance with a line type. In FIG. 2, the magnitude relation of a duty ratio DH1 to a duty ratio DH3 is “the duty ratio DH2>the duty ratio DH3>the duty ratio DH1.” In addition, in FIG. 2, the magnitude relation of a duty ratio DH4 to a duty ratio DH8 is “the duty ratio DH7>the duty ratio DH5>the duty ratio DH6>the duty ratio DH4>the duty ratio DH8.”

In a period of a timing TA to a timing TB, since the input voltage value is higher than the upper-limit voltage value z1, the control device 20 controls the switching power supply circuit 10 in the step-down mode. For this reason, within this period, the first duty ratio is changed through feedback control. More specifically, within a period of the timing TA to the timing T1, the first duty ratio is maintained to be a duty ratio DH1 through feedback control. Then, within a period of the timing T1 to the timing TB, the first duty ratio is raised from the duty ratio DH1 to a duty ratio DH2 through feedback control. On the other hand, within the period of the timing TA to the timing TB, the second duty ratio is maintained to be 0% through linear change control. Here, in the embodiment, changes of the second duty ratio are treated as linear changes of a case in which the predetermined change rate is 0.

In a period of the timing TB to the timing TC, since the input voltage value is the upper-limit voltage value z1 or less, and the input voltage value is the lower-limit voltage value z2 or more, the control device 20 controls the switching power supply circuit 10 in the step-up/down mode. For this reason, within this period, the first duty ratio is changed through linear change control. More specifically, within a period of the timing TB to the timing T2, the first duty ratio falls from the duty ratio DH2 to a duty ratio DH3 through linear change control. Here, the duty ratio DH3 is the lower-limit value of the first duty ratio in linear change control. For this reason, within a period of the timing T2 to a timing TC, the first duty ratio is maintained to be the duty ratio DH3 through linear change control. On the other hand, within the period of the timing TB to the timing TC, the second duty ratio is changed through feedback control. More specifically, within the period of the timing TB to the timing T2, the second duty ratio rises from 0% to a duty ratio DH4. Then, within the period of the timing T2 to the timing TC, the second duty ratio rises from the duty ratio DH4 to the duty ratio DH5.

In the period of the timing TC to the timing TD, since the input voltage value is lower than the lower-limit voltage value z2, the control device 20 controls the switching power supply circuit 10 in the step-up mode. For this reason, within this period, the first duty ratio is changed through linear change control. More specifically, within the period of the timing TC to the timing T3, the first duty ratio is raised from the duty ratio DH3 to 100% through linear change control. Here, 100% is the upper-limit value of the first duty ratio in linear change control. For this reason, within the period of the timing T3 to the timing TD, the first duty ratio is maintained to be 100% through linear change control. On the other hand, within the period of the timing TC to the timing TD, the second duty ratio is changed through feedback control. More specifically, within the period of the timing TC to the timing T3, the second duty ratio falls from the duty ratio DH5 to the duty ratio DH6. In addition, within the period of the timing T3 to the timing T4, the second duty ratio rises from the duty ratio DH6 to the duty ratio DH7. Within the period of the timing T4 to the timing T5, the second duty ratio is maintained to be the duty ratio DH7. Then, within the period of the timing T5 to the timing TD, the second duty ratio falls from the duty ratio DH7 to the duty ratio DH8.

In a period of the timing TD to a timing TE, since the input voltage value is the upper-limit voltage value z1 or less, and the input voltage value is the lower-limit voltage value z2 or more, the control device 20 controls the switching power supply circuit 10 in the step-up/down mode. For this reason, within this period, the first duty ratio is changed through linear change control. More specifically, within the period of the timing TD to the timing T6, the first duty ratio is lowered from 100% to the duty ratio DH3 through linear change control. Here, as described above, the duty ratio DH3 is the lower-limit value of the first duty ratio of linear change control. For this reason, within the period of the timing T6 to the timing TE, the first duty ratio is maintained to be the duty ratio DH3 through linear change control. On the other hand, within the period of the timing TD to the timing TE, the second duty ratio is changed through feedback control. More specifically, within the period of the timing TD to the timing T6, the second duty ratio rises from the duty ratio DH8 to the duty ratio DH6. Then, within the period of the timing T6 to the timing TE, the second duty ratio falls from the duty ratio DH6 to 0%.

In a period after the timing TE, since the input voltage value is higher than the upper-limit voltage value z1, the control device 20 controls the switching power supply circuit 10 in the step-down mode. For this reason, within this period, the first duty ratio is changed through feedback control. More specifically, within a period of the timing TE to the timing T7, the first duty ratio is lowered from the duty ratio DH3 to the duty ratio DH1 through feedback control. Then, within a period after the timing T7, the first duty ratio is maintained to be the duty ratio DH1 through feedback control. On the other hand, within a period after the timing TE, the second duty ratio is maintained to be 0% through linear change control.

As described above, the control device 20 changes the first duty ratio and the second duty ratio while performing switching of the operation mode in accordance with a change of the input voltage value. Here, in the example illustrated in FIG. 2, timings at which the operation mode is switched are the timing TB, the timing TC, the timing TD, and the timing TE. At each of the timing TB, the timing TC, the timing TD, and the timing TE, the control device 20 continuously changes the first duty ratio and continuously changes the second duty ratio. More specifically, in a case in which the operation mode is to be switched at each of the timing TB, the timing TC, the timing TD, and the timing TE, the control device 20 linearly changes the first duty ratio after operation mode switching from a first start point with the first duty ratio before operation mode switching set as the first start point and linearly changes the second duty ratio after operation mode switching from a second start point with the second duty ratio before operation mode switching set as the second start point. For example, at the timing TB, the first duty ratio before operation mode switching is the duty ratio DH2. For this reason, the control device 20 specifies the duty ratio DH2 as a first start point at the timing TB and linearly changes the first duty ratio after operation mode switching from the duty ratio DH2 that is the specified first start point to the duty ratio DH3. For example, at the timing TB, the second duty ratio before operation mode switching is 0%. For this reason, the control device 20 specifies 0% as a second start point at the timing TB and linearly changes the second duty ratio after operation mode switching to the duty ratio DH4 from 0% that is the specified second start point. Such a situation is similar at each of the timing TC to the timing TE. For this reason, a function for drawing the curve F4 representing changes of the first duty ratio over time and a function for drawing the curve F5 representing changes of the second duty ratio over time become continuous functions. In other words, the first duty ratio and the second duty ratio do not discontinuously change at the time of operation mode switching. In accordance with this, as represented in the curve F2 illustrated in FIG. 2, the control device 20 can inhibit generation of ripples in the input voltage at the time of switching the operation mode.

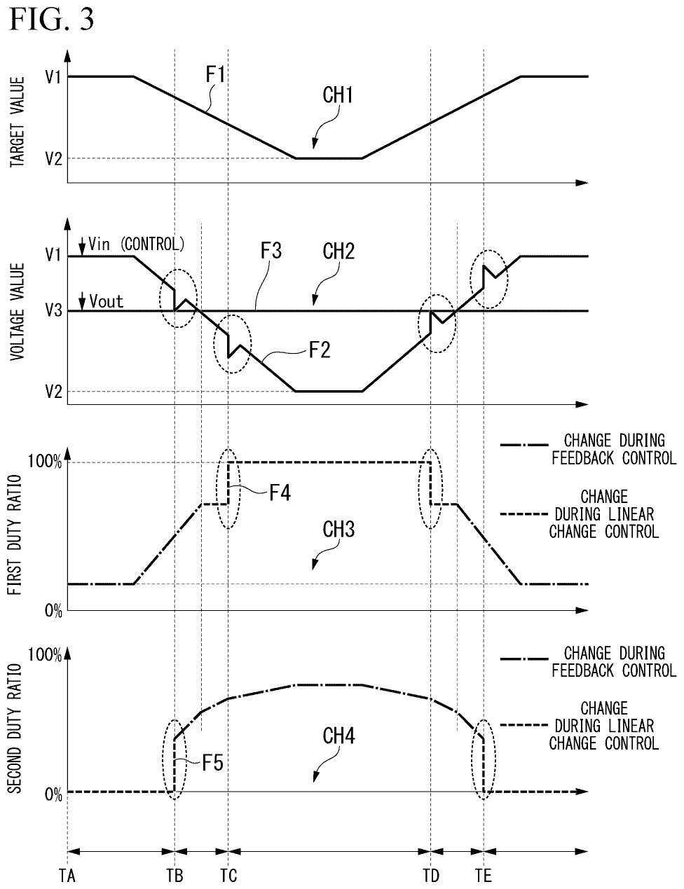

Here, FIG. 3 is a diagram explaining changes of an input voltage value over time in a case in which a duty ratio is nonlinearly changed at the time of operation mode switching. Similar to FIG. 2, in FIG. 3, four timing charts including timing charts CH1 to CH4 are illustrated. Changes of the target value over time in the timing chart CH1 illustrated in FIG. 3 are similar to the changes of the target value over time in the timing chart CH1 illustrated in FIG. 2. Similar to the example illustrated in FIG. 2, timings at which the control device 20 performs switching of the operation mode in FIG. 3 are timings TB to TE. However, in the example illustrated in FIG. 3, the second duty ratio nonlinearly changes at timings TB and TE. In other words, in this example, at the timings TB and TE, the second duty ratio discontinuously changes. In this example, the first duty ratio nonlinearly changes at timings TC and TD. In other words, in this example, the first duty ratio discontinuously changes at the timings TC and TD. As a result, in the example illustrated in FIG. 3, in a curve F2 representing changes of the input voltage value over time, ripples are generated at each of the timings TB, TC, TD, and TE. This causes application of a load to a circuit element of the switching power supply circuit 10, which is not desirable.

As a method for inhibiting generation of ripples in a curve representing changes of the input voltage value over time, an output fluctuation suppression method is known. However, it is known that the output fluctuation suppression method cannot inhibit generation of ripples in a curve representing changes of an input voltage value over time that are generated at the time of operation mode switching at a time when an output voltage value varies. In addition, it is also known that the output fluctuation suppression method is not appropriate for maximum power point tracking control of a solar panel in a case in which the DC power supply P is a solar panel as in this example. In a case in which the output fluctuation suppression method is adopted, in order to switch the polarity of a differential calculator used for error calculation, the structure, control, and the like of the switching power supply device 1 become complex, which may hinder practical application thereof to a power supply device for a solar panel.

Thus, in the switching power supply device 1, as described above, in a case in which the operation mode is to be switched, the control device 20 linearly changes the first duty ratio after operation mode switching from a first start point with the first duty ratio before operation mode switching set as the first start point and linearly changes the second duty ratio after operation mode switching from a second start point with the second duty ratio before operation mode switching set as the second start point. In accordance with this, the control device 20 can inhibit generation of ripples in an input voltage at the time of switching the operation mode. In addition, in this example, a solar panel is connected to the switching power supply circuit 10 as a DC power supply P. In other words, the method of controlling the first duty ratio and the second duty ratio using the control device 20 described in the embodiment is appropriate also for maximum power point tracking control of a solar panel. As a result, this control method does not hinder practical application to a power supply device for a solar panel. Thus, this control method can provide a switching power supply device having higher versatility than the output fluctuation suppression method.

In this embodiment, the first duty ratio nonlinearly changing at the time of operation mode switching represents that the first duty ratio is rapidly changed before and after operation mode switching such that it can be regarded that the first duty ratio after operation mode switching starts to be changed from the first start point at which it does not coincide with the first duty ratio before operation mode switching. In addition, in this embodiment, the second duty ratio nonlinearly changing at the time of operation mode switching represents that the second duty ratio is rapidly changed before and after operation mode switching such that it can be regarded that the second duty ratio after operation mode switching starts to be changed from the second start point at which it does not coincide with the second duty ratio before operation mode switching. In the embodiment, the first duty ratio before operation mode switching is the first duty ratio at a timing at which it is determined by the control device Bat switching of the operation mode has been performed. In addition, in the embodiment, the second duty ratio before operation mode switching is the second duty ratio at a timing at which it is determined by the control device Bat switching of the operation mode has been performed.

### <Configuration of Control Device>

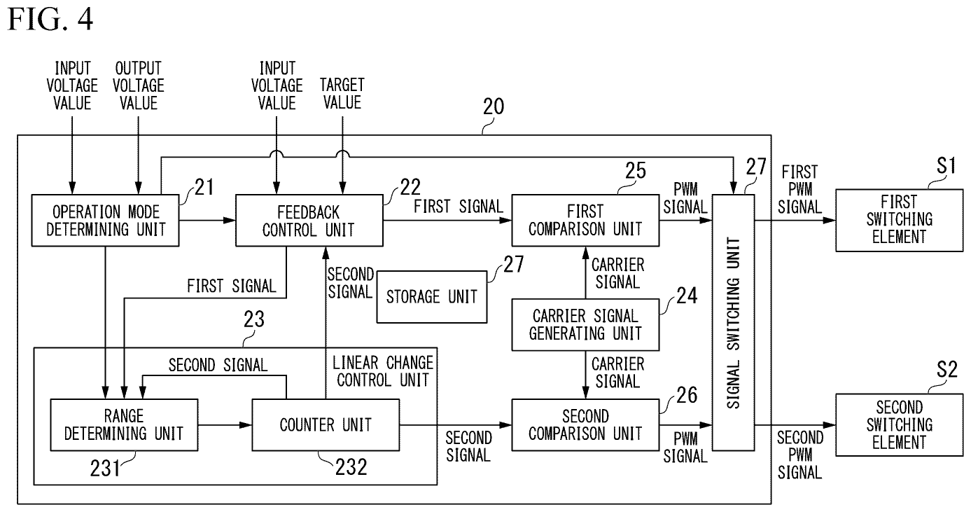

Hereinafter, the configuration of the control device 20 will be described with reference to FIG. 4. FIG. 4 is a diagram illustrating one example of the configuration of the control device 20.

The control device 20 includes an operation mode determining unit 21, a feedback control unit 22, a linear change control unit 23, a carrier signal generating unit 24, a first comparison unit 25, a second comparison unit 26, a signal switching unit 27, and a storage unit 28. At least one of the operation mode determining unit 21, the feedback control unit 22, the linear change control unit 23, the carrier signal generating unit 24, the first comparison unit 25, the second comparison unit 26, and the signal switching unit 27 may be software functional units executed by various processors or may be hardware functional units configured by various circuits, ASICs (Application Specific Integrated Circuits), and the like.

The operation mode determining unit 21 determines which one of the step-up mode, the step-up/down mode, and the step-down mode the operation mode is. The operation mode determining unit 21 may have any configuration as long as it can determine which one of the step-up mode, the step-up/down mode, and the step-down mode the operation mode is. Hereinafter, for the convenience of description, determination of which one of the step-up mode, the step-up/down mode, and the step-down mode the operation mode is will be referred to as determination of an operation mode in description. In the example illustrated in FIG. 4, the operation mode determining unit 21 determines the operation mode based on an input voltage value and an output voltage value. The operation mode determining unit 21 outputs information representing a result of the determination, that is, operation mode information indicating the determined operation mode to the feedback control unit 22, the linear change control unit 23, and the signal switching unit 27. In addition, the operation mode determining unit 21 reads operation mode information stored in the storage unit 28 at the previous time and outputs the read operation mode information to the feedback control unit 22 and the linear change control unit 23 as previous-time operation mode information indicating an operation mode that has been determined at the previous time by the operation mode determining unit 21. Then, the operation mode determining unit 21 substitutes the operation mode information stored in the storage unit 28 with operation mode information indicating an operation mode determined at this time. At the time of a first-time operation of the operation mode determining unit 21, operation mode information indicating an operation mode determined in advance is stored in the storage unit 28. In addition, the operation mode determining unit 21 may be configured to determine an operation mode using another method. Furthermore, the operation mode determining unit 21 may be configured to output operation mode information to the feedback control unit 22, the linear change control unit 23, and the signal switching unit 27 using different methods. In addition, the operation mode determining unit 21 may be configured to output previous-time operation mode information to the feedback control unit 22 and the linear change control unit 23 using different methods. For this reason, the operation mode determining unit 21 may be configured not to store operation mode information in the storage unit 28. Details of the process performed by the operation mode determining unit 21 will be described below.

The feedback control unit 22 determines whether or not the operation mode has switched based on the operation mode information and the previous-time operation mode information acquired from the operation mode determining unit 21. Then, in accordance with feedback control according to a determination result representing whether or not the operation mode has switched, the feedback control unit 22 outputs a first signal to be compared with a carrier signal for generating a PWM signal. More specifically, the feedback control unit 22 outputs a first signal to be compared with a carrier signal for generating a PWM signal in this feedback control changing the first duty ratio and this feedback control changing the second duty ratio. In addition, the feedback control unit 22 outputs a first signal using feedback control based on an input voltage value detected by the control device 20, a target value, and a second signal to be described below. Here, the voltage value of a voltage represented by the first signal is a value corresponding to a difference between this input voltage value and this target value. For this reason, hereinafter, for the convenience of description, the voltage value of the voltage represented by the first signal will be referred to as a first comparative value in description. In other words, the first signal is a signal that represents the voltage of the first comparative value. In addition, the input of an input voltage value to the feedback control unit 22 may be performed by inputting information representing the input voltage value, may be performed by inputting a signal representing the voltage of the input voltage value, or may be performed using another method. Furthermore, the input of a target value to the feedback control unit 22 may be performed by inputting information representing the target value, may be performed by inputting a reference voltage of which a voltage value is the target value, or may be performed using another method. Hereinafter, for the convenience of description, a carrier signal generated by the carrier signal generating unit 24 will be simply referred to as a carrier signal in description. The feedback control unit 22 outputs the first signal to a first comparison unit 25 to be described below and outputs the first signal also to the linear change control unit 23. Details of the process performed by the feedback control unit 22 will be described below.

The linear change control unit 23 determines whether or not the operation mode has been switched based on the operation mode information and the previous-time operation mode information acquired from the operation mode determining unit 21. Then, in accordance with linear change control according to a determination result indicating whether or not the operation mode has been switched, the linear change control unit 23 outputs a second signal to be compared with a carrier signal for generating a PWM signal. More specifically, the linear change control unit 23 outputs a second signal to be compared with a carrier signal for generating a PWM signal in this linear change control changing the first duty ratio and this linear change control changing the second duty ratio. The linear change control unit 23 includes a range determining unit 231 and a counter unit 232. Hereinafter, for the convenience of description, the voltage value of a voltage represented by the second signal will be referred to as a second comparative value in description. In other words, the second signal is a signal that represents the voltage of the second comparative value.

The range determining unit 231 determines a range in which the second comparative value of the voltage represented by the second signal is changed every time the operation mode has been switched based on the operation mode determined at this time by the operation mode determining unit 21, the operation mode that has been determined at the previous time by the operation mode determining unit 21, the voltage value of the voltage represented by the first signal output by the feedback control unit 22 and the second signal that has been output at the previous time. For this reason, the range determining unit 231 does nothing as long as the operation mode has not been switched. The range determining unit 231 determines a range in which the second signal is changed only at the time of a first-time operation based on an operation mode determined at this time by the operation mode determining unit 21, an operation mode that has been determined at the previous time by the operation mode determining unit 21, a first signal output by the feedback control unit 22, and a second signal representing the voltage of a second comparative value of a case in which the second comparative value is an initial value determined in advance. This initial value may be any value as long as it does not impair the function of the control device 20 described in the embodiment. Hereinafter, for the convenience of description, a range determined by the range determining unit 231 will be simply referred to as a target range in description. In this example, although the range determining unit 231 specifies the operation mode determined at this time by the operation mode determining unit 21 based on the operation mode information acquired from the operation mode determining unit 21, it may be configured to specify the operation mode using another method. In addition, in this example, although the range determining unit 231 specifies the operation mode that has been determined at the previous time by the operation mode determining unit 21 based on the previous-time mode information acquired from the operation mode determining unit 21, it may be configured to specify the operation mode using another method. Every time the target range is determined, the range determining unit 231 outputs information representing the determined target range to the counter unit 232. Details of the process performed by the range determining unit 231 will be described below.

The counter unit 232 changes the second comparative value of the voltage represented by the second signal from a start point to an end point of the target range determined by the range determining unit 231 with a predetermined change ratio and outputs a second signal every time the second comparative value is changed. For example, in a case in which this range is 2 V to 5 V, the start point is 2 V, the end point is 5 V, and the predetermined change rate is 0.1 V, the counter unit 232 outputs second signals in order of a second signal representing a voltage of 2 V, a second signal representing a voltage of 2.1 V, a second signal representing a voltage of 2.2 V, . . . , a second signal representing a voltage of 4.9 V, and a second signal representing a voltage of 5 V. In addition, for example, in a case in which this range is 2 V to 5 V, the start point is 5 V, the end point is 2 V, and the predetermined change rate is 0.1 V, the counter unit 232 outputs second signals in order of a second signal representing a voltage of 5 V, a second signal representing a voltage of 4.9 V, a second signal representing a voltage of 4.8 V, . . . , a second signal representing a voltage of 2.1 V, and a second signal representing a voltage of 2 V. Such second comparative voltage values of the voltages of the second signals are merely examples for easy understanding and are values different from second comparative values that are actually used. In addition, the counter unit 232 outputs the second signals to a second comparison unit 26 to be described below and outputs the second signals also to the range determining unit 231 and the feedback control unit 22. Details of the process performed by the counter unit 232 will be described below.

The carrier signal generating unit 24 generates a carrier signal of a frequency determined in advance. A method of generating a carrier signal using the carrier signal generating unit 24 may be a known method or a method to be developed from now on. This frequency may be any frequency as long as it is a frequency for which a PWM signal can be generated. Details of the process performed by the carrier signal generating unit 24 will be described below.

The first comparison unit 25 generates a PWM signal according to comparison of the first signal with the carrier signal as a A PWM signal. A method of generating a PWM signal using the first comparison unit 25 may be a known method or a method to be developed from now on. Details of the process performed by the first comparison unit 25 will be described below.

The second comparison unit 26 generates a PWM signal according to comparison of the second signal with the carrier signal as a B PWM signal. A method of generating a PWM signal using the second comparison unit 26 may be a known method or a method to be developed from now on. Details of the process performed by the second comparison unit 26 will be described below.

The signal switching unit 27 specifies which one of the step-down mode, the step-up/down mode, and the step-up mode the operation mode determined at this time by the operation mode determining unit 21 is based on the operation mode information acquired from the operation mode determining unit 21. Then, in a case in which the operation mode determined at this time by the operation mode determining unit 21 is specified to be the step-down mode, the signal switching unit 27 inputs the A PWM signal generated by the first comparison unit 25 to the first switching element S1 as a first PWM signal and inputs the B PWM signal generated by the second comparison unit 26 to the second switching element as a second PWM signal. In addition, in a case in which the operation mode determined at this time by the operation mode determining unit 21 is specified to be the step-up/down mode or the step-up mode, the signal switching unit 27 inputs the B PWM signal generated by the second comparison unit 26 to the first switching element S1 as a first PWM signal and inputs the A PWM signal generated by the first comparison unit 25 to the first switching element S1 as a first PWM signal. In other words, the signal switching unit 27 switches output destinations of two PWM signals in accordance with an operation mode determined at this time by the operation mode determining unit 21. The signal switching unit 27 may be configured to specify an operation mode determined at this time by the operation mode determining unit 21 based on the operation mode information stored in the storage unit 28 or may be configured to specify this operation mode using another method.

The storage unit 28 stores various kinds of information used in the control device 20. For example, the storage unit 28 stores operation mode information that represents an operation mode determined at this time by the operation mode determining unit 21.

In accordance with the configuration described above, in a case in which the operation mode in which the switching power supply circuit 10 is operated is switched, the control device 20 linearly changes the first duty ratio after operation mode switching from the first start point and linearly changes the second duty ratio after operation mode switching from the second start point. In accordance with this, the control device 20 can inhibit generation of ripples in the input voltage at the time of switching the operation mode.

### <Process Performed by Operation Mode Determining Unit>

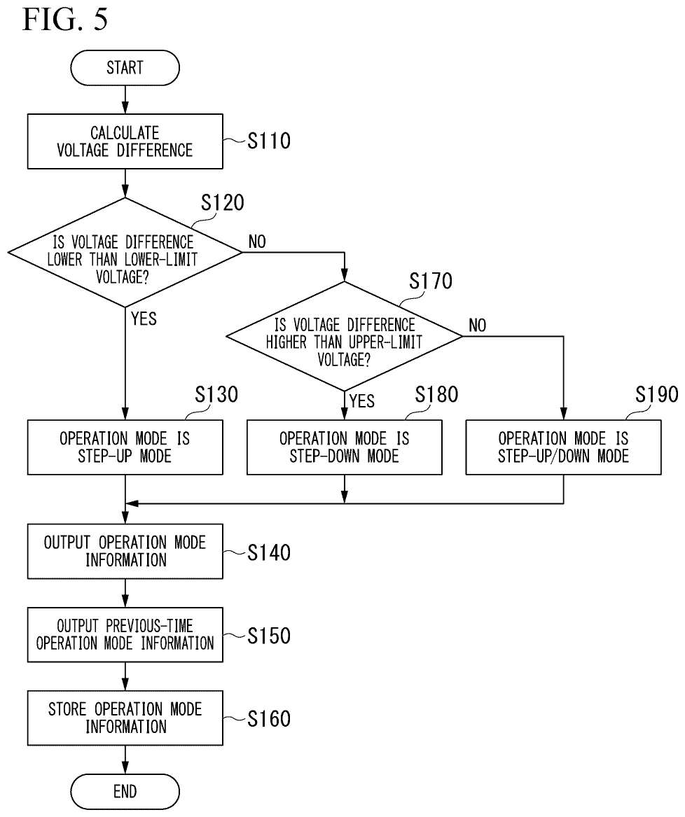

Hereinafter, the process performed by the operation mode determining unit 21 will be described with reference to FIG. 5. FIG. 5 is a diagram illustrating one example of the flow of the process performed by then operation mode determining unit 21.

The operation mode determining unit 21 calculates a difference between an input voltage value detected by the input voltage detecting unit and an output voltage value detected by the output voltage detecting unit as a voltage difference (Step S110).

Next, the operation mode determining unit 21 determines whether or not the voltage difference calculated in Step S110 is lower than the lower-limit voltage value z2 described above (Step S120). In FIG. 5, the process of Step S120 is represented using “IS VOLTAGE DIFFERENCE LOWER THAN LOWER-LIMIT VOLTAGE?”.

In a case in which it is determined that the voltage difference calculated in Step S110 is lower than the lower-limit voltage value z2 (Step S120—Yes), the operation mode determining unit 21 specifies that the operation mode is the step-up mode (Step S130). In FIG. 5, the process of Step S130 is represented using “OPERATION MODE IS STEP-UP MODE”.

After the process of Step S130 is performed, the operation mode determining unit 21 outputs operation mode information indicating the operation mode specified at this time to the feedback control unit 22, the range determining unit 231 of the linear change control unit 23, and the signal switching unit 27 (Step S140). In FIG. 5, the process of Step S140 is represented using “OUTPUT OPERATION MODE INFORMATION”.

Next, the operation mode determining unit 21 reads operation mode information stored in the storage unit 28 as previous-time operation mode information indicating the operation mode determined at the previous time and outputs the read previous-time operation mode information to the feedback control unit 22 and the range determining unit 231 (Step S150). In FIG. 5, the process of Step S150 is represented using “OUTPUT PREVIOUS-TIME OPERATION MODE INFORMATION”.

Next, the operation mode determining unit 21 stores operation mode information indicating the operation mode specified at this time in the storage unit 28 (Step S160). Then, the operation mode determining unit 21 ends the process of the flowchart illustrated in FIG. 5. In FIG. 5, the process of Step S160 is represented using “STORE OPERATION MODE INFORMATION”.

On the other hand, in a case in which it is determined that the voltage difference calculated in Step S110 is the lower-limit voltage value z2 or more (Step S120—No), the operation mode determining unit 21 determines whether or not the voltage difference calculated in Step S110 is higher than the upper-limit voltage value z1 described above (Step S170). In FIG. 5, the process of Step S170 is represented using “IS VOLTAGE DIFFERENCE HIGHER THAN UPPER-LIMIT VOLTAGE?”.

In a case in which it is determined that the voltage difference calculated in Step S110 is higher than the upper-limit voltage value z1 (Step S170—Yes), the operation mode determining unit 21 specifies that the operation mode is the step-down mode (Step S180). In FIG. 5, the process of Step S180 is represented using “OPERATION MODE IS STEP-DOWN MODE”.

After the process of Step S180 is performed, the operation mode determining unit 21 proceeds to Step S140 and outputs the operation mode information indicating the operation mode specified at this time to the feedback control unit 22, the range determining unit 231 of the linear change control unit 23, and the signal switching unit 27.

On the other hand, in a case in which it is determined that the voltage difference calculated in Step S110 is the upper-limit voltage value z1 or less (Step S170—No), the operation mode determining unit 21 specifies that the operation mode is the step-up/down mode (Step S190). In FIG. 5, the process of Step S190 is represented using “OPERATION MODE IS STEP-UP/DOWN MODE”.

After the process of Step S190 is performed, the operation mode determining unit 21 proceeds to Step S140 and outputs the operation mode information indicating the operation mode specified at this time to the feedback control unit 22, the range determining unit 231 of the linear change control unit 23, and the signal switching unit 27.

In addition, the operation mode determining unit 21 may be configured not to output the operation mode information to at least one of the feedback control unit 22, the range determining unit 231, and the signal switching unit 27. In this case, at least one of the feedback control unit 22, the range determining unit 231, and the signal switching unit 27 read the operation mode information stored in the storage unit 28 from the storage unit 28, thereby specifying the operation mode determined at this time by the operation mode determining unit 21. In addition, the operation mode determining unit 21 may be configured not to output the previous-time operation mode information to one or both of the feedback control unit 22 and the range determining unit 231. In this case, one or both of the feedback control unit 22 and the range determining unit 231 reads the operation mode information stored in the storage unit 28 from the storage unit 28, thereby specifying the operation mode determined at the previous time by the operation mode determining unit 21. In other words, in this case, the operation mode determining unit 21 stores both the operation mode information and the previous-time operation mode information in the storage unit 28.

As described above, the operation mode determining unit 21 determines which one of the step-up mode, the step-up/down mode, and the step-down mode the operation mode is.

### <Function of Feedback Control Unit>

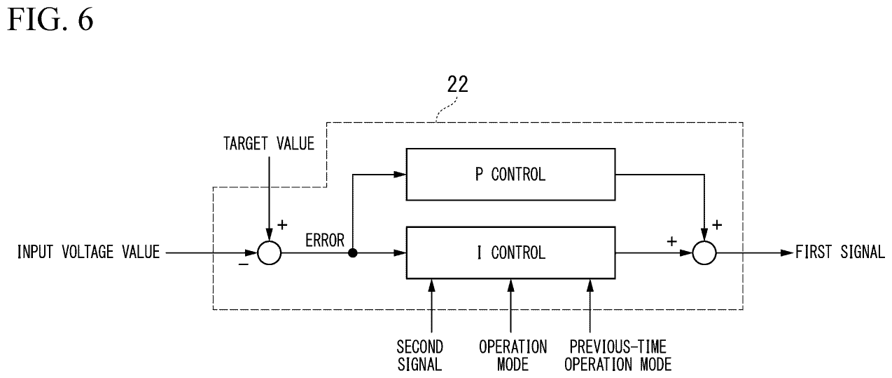

Hereinafter, the function of the feedback control unit 22 will be described with reference to FIG. 6. FIG. 6 is a diagram illustrating one example of a block diagram illustrating feedback control performed by the feedback control unit 22.

The input voltage value, the target value, the operation mode information, the previous-time operation mode information and the second signal output from the counter unit 232 are input to the feedback control unit 22. A control target according to the feedback control unit 22 is the first comparative value of the voltage represented by the first signal.

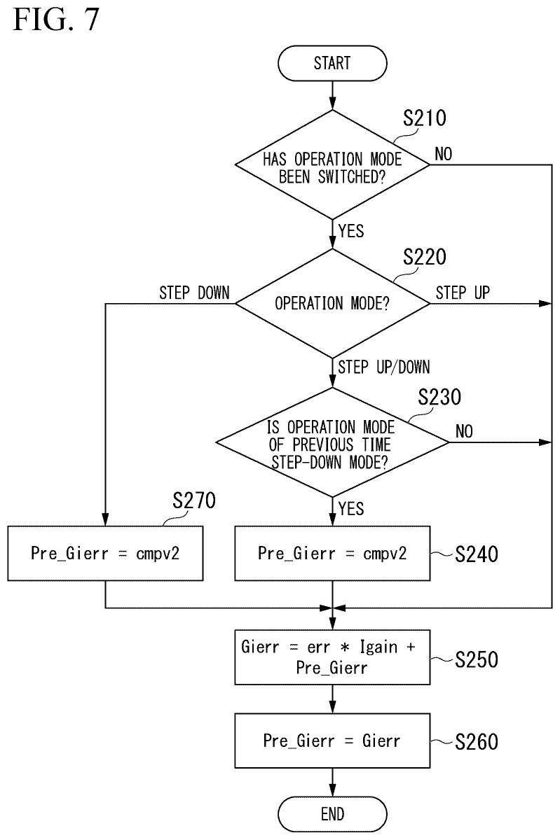

The feedback control unit 22 calculates a difference between the input voltage value detected by the input voltage detecting unit and the target value as error in the feedback control. Then, the feedback control unit 22 calculates a value obtained by adding a P (Proportional) control output value output through P control based on the calculated error and an I (Integration) control output value output through I control based on the calculated error as the first comparative value described above. The feedback control unit 22 outputs a first signal that represents a voltage of the calculated first comparative value. Here, the P control performed by the feedback control unit 22 is a known control using a P gain, and thus description thereof will be omitted. In addition, the I control performed by the feedback control unit 22 is performed using the process of a flowchart illustrated in FIG. 7. In a case in which the I control is performed, the feedback control unit 22 uses input operation mode information and input previous-time operation mode information.

### <Process of Feedback Control Unit Performing the I Control>

Hereinafter, the process of the feedback control unit 22 performing the I control will be described with reference to FIG. 7. FIG. 7 is a diagram illustrating one example of the flow of the process of the feedback control unit 22 performing the I control.

The feedback control unit 22 determines whether or not the operation mode has been switched based on input operation mode information and input previous-time operation mode information (Step S210). More specifically, in a case in which an operation mode indicated by this operation mode information and an operation mode indicated by this previous-time operation mode information coincide with each other, the feedback control unit 22 determines that the operation mode has not been switched. On the other hand, in a case in which an operation mode indicated by this operation mode information and an operation mode indicated by this previous-time operation mode information do not coincide with each other, the feedback control unit 22 determines that the operation mode has been switched. In FIG. 7, the process of Step S210 is represented using “HAS OPERATION MODE BEEN SWITCHED?”.

In a case in which it is determined that the operation mode has not been switched (Step S210—No), the feedback control unit 22 outputs a value obtained by adding a value, which is obtained by multiplying the error calculated in the previous stage of I control by an I gain, and an I control output value of the previous time as a this-time the I control output value (Step S250). In addition, the feedback control unit 22 uses a value that has been determined in advance as an initial value of the I control output value as the I control output value of the previous time at the time of a first-time operation. In FIG. 7, the error is denoted by err, the I gain is denoted by Igain, the I control output value of the previous time is denoted by Pre_Gierr, the I control output value to be output is denoted by Gierr, and the second comparative value of the voltage represented by the second signal is denoted by cmpv2. In FIG. 7, the process of Step S250 is represented using “Gierr=err*Igain+Pre_Gierr.”

Next, the feedback control unit 22 specifies the I control output value output in Step S250 as the I control output value of the previous time (Step S260). In FIG. 7, the process of Step S260 is represented using “Pre_Gierr=Gierr.” After the process of Step S260 is performed, the feedback control unit 22 ends the process of the flowchart illustrated in FIG. 7.

On the other hand, in a case in which it is determined that the operation mode has been switched (Step S210—Yes), the feedback control unit 22 determines which one of the step-down mode, the step-up/down mode, and the step-up mode the operation mode after switching is based on the input operation mode information (Step S220). In FIG. 7, the process of Step S220 is represented using “OPERATION MODE?”.

In a case in which it is determined that the operation mode after switching is the step-down mode (Step S220—the step-down mode), the feedback control unit 22 specifies the second comparative value of the voltage represented by the input second signal as the I control output value of the previous time (Step S270). In FIG. 7, the process of Step S270 is represented using “Pre_Gierr=cmpv2.” The process of Step S270 is a process that is performed for continuously changing the first duty ratio and the second duty ratio at the time of switching the operation mode to the step-down mode. The reason for this will be described below.

Next, the feedback control unit 22 proceeds to Step S250 and outputs a value obtained by adding a value, which is obtained by multiplying error calculated in the previous stage of the I control by the I gain, and the I control output value of the previous stage specified in Step S270 as the I control output value.

On the other hand, in a case in which it is determined that the operation mode after switching is the step-up/down mode (Step S220—the step-up/down mode), the feedback control unit 22 determines whether or not the operation mode before switching is the step-down mode based on the previous-time operation mode information (Step S230). In FIG. 7, the process of Step S230 is represented using “IS OPERATION MODE OF PREVIOUS TIME STEP DOWN MODE?”.

In a case in which it is determined that the operation mode before switching is the step-down mode (Step S230—Yes), the feedback control unit 22 specifies the second comparative value of the voltage represented by the input second signal as the I control output value of the previous time (Step S240). In FIG. 7, the process of Step S240 is represented using “Pre_Gierr=cmpv2.” The process of Step S240 is a process that is performed for continuously changing the first duty ratio and the second duty ratio at the time of switching the operation mode from the step-down mode to the step-up/down mode. The reason for this will be described below.

Next, the feedback control unit 22 proceeds to Step S250 and outputs a value obtained by adding a value, which is obtained by multiplying error calculated in the previous stage of the I control by the I gain, and the I control output value of the previous time specified in Step S270 as the I control output value.

On the other hand, in a case in which it is determined that the operation mode before switching is not the step-down mode (Step S230—No), the feedback control unit 22 proceeds to Step S250 and outputs a value obtained by adding a value, which is obtained by multiplying error calculated in the previous stage of the I control by the I gain, and the I control output value of the previous time specified in the process of Step S260 executed at the previous time as the I control output value.

As described above, the feedback control unit 22 outputs the I control output value through the I control. In this example, the feedback control unit 22 calculates a first comparative value through feedback control and can output a first signal representing the voltage of the calculated first comparative value.

### <Process Performed by Range Determining Unit>

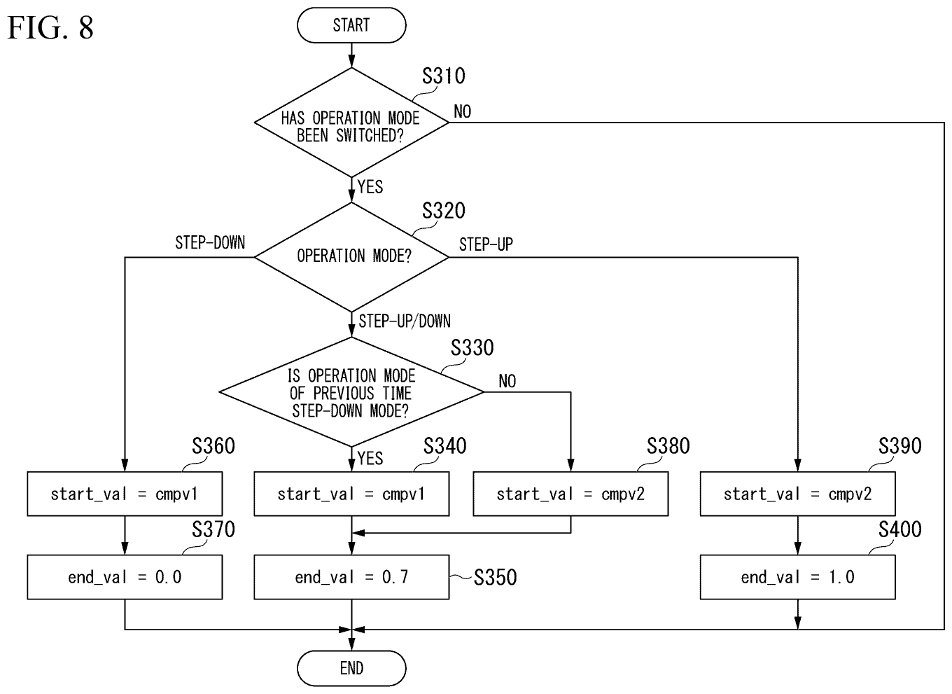

Hereinafter, the process performed by the range determining unit 231 will be described with reference to FIG. 8. FIG. 8 is a diagram illustrating one example of the flow of the process performed by the range determining unit 231.

The range determining unit 231 determines whether or not the operation mode has been switched based on input operation mode information and input previous-time operation mode information (Step S310). More specifically, in a case in which an operation mode indicated by this operation mode information and an operation mode indicated by this previous-time operation mode information coincide with each other, the range determining unit 231 determines that the operation mode has not been switched. On the other hand, in a case in which an operation mode indicated by this operation mode information and an operation mode indicated by this previous-time operation mode information do not coincide with each other, the range determining unit 231 determines that the operation mode has been switched. In FIG. 8, the process of Step S310 is represented using “HAS OPERATION MODE BEEN SWITCHED?”.

In a case in which it is determined that the operation mode has not been switched (Step S310—No), the range determining unit 231 ends the process of the flowchart illustrated in FIG. 8 without performing any operation.

On the other hand, in a case in which it is determined that the operation mode has been switched (Step S310—Yes), the range determining unit 231 determines which one of the step-down mode, the step-up/down mode, and the step-up mode the operation mode after switching is based on the input operation mode information (Step S320). In FIG. 8, the process of Step S320 is represented using “OPERATION MODE?”.

In a case in which it is determined that the operation mode after switching is the step-down mode (Step S320—the step-down mode), the range determining unit 231 specifies the first comparative value of the voltage represented by the input first signal as a start point of a target range (Step S360). Here, in FIG. 8, the first comparative value is denoted by cmpv1, and the start point of the target range is denoted by start_val. For this reason, in FIG. 8, the process of Step S360 is represented using “start_val=cmpv1.” The process of Step S360 is a process that is performed for continuously changing the first duty ratio and the second duty ratio at the time of switching the operation mode to the step-down mode. The reason for this will be described below.

Next, the range determining unit 231 specifies 0.0 as an end point of the target range (Step S370). Here, 0.0 is a value determined in advance as an end point of the target range of a case in which the operation mode is the step-down mode. In FIG. 8, the end point of the target range is denoted by end_val. For this reason, in FIG. 8, the process of Step S370 is represented using “end_val=0.0.” After the process of Step S370 is performed, the range determining unit 231 outputs information representing a start point and an end point of the target range to the counter unit 232 and ends the process of the flowchart illustrated in FIG. 8.

On the other hand, in a case in which it is determined that the operation mode after switching is the step-up/down mode (Step S320—the step-up/down mode), the range determining unit 231 determines whether or not the operation mode before switching is the step-down mode based on the previous-time operation mode information (Step S330). In FIG. 8, the process of Step S330 is represented using “IS OPERATION MODE OF PREVIOUS TIME STEP-DOWN MODE?”.

In a case in which it is determined that the operation mode before switching is the step-down mode (Step S330—Yes), the range determining unit 231 specifies the first comparative value of the voltage represented by the input first signal as the start point of the target range (Step S340). Here, in FIG. 8, the process of Step S340 is represented using “start_val=cmpv1.” The process of Step S340 is a process that is performed for continuously changing the first duty ratio and the second duty ratio at the time of switching the operation mode from the step-down mode to the step-up/down mode. The reason for this will be described below.

Next, the range determining unit 231 specifies 0.7 as the end point of the target range (Step S350). Here, 0.7 is a value that is determined in advance as the end point of the target range in a case in which the operation mode is the step-up/down mode. In FIG. 8, the process of Step S350 is represented using “end_val=0.7.” After the process of Step S350 is performed, the range determining unit 231 outputs information representing the start point and the end point of the target range to the counter unit 232 and ends the process of the flowchart illustrated in FIG. 8.

On the other hand, in a case in which it is determined that the operation mode before switching is not the step-down mode (Step S330—No), the range determining unit 231 specifies the second comparative value of the voltage represented by the input second signal as the start point of the target range (Step S380). Here, in FIG. 8, the second comparative value is denoted by cmpv2. For this reason, in FIG. 8, the process of Step S380 is represented using “start_val=cmpv2.”

Next, the range determining unit 231 proceeds to Step S350 and specifies 0.7 as the end point of the target range. After the process of Step S350 is performed, the range determining unit 231 outputs information representing the start point and the end point of the target range to the counter unit 232 and ends the process of the flowchart illustrated in FIG. 8.

On the other hand, in a case in which it is determined that the operation mode after switching is the step-up mode (Step S320—the step-up mode), the range determining unit 231 specifies the second comparative value of the voltage represented by the input second signal as the start point of the target range (Step S390). Here, in FIG. 8, the process of Step S390 is represented using “start_val=cmpv2.”

Next, the range determining unit 231 specifies 1.0 as the end point of the target range (Step S400). Here, 1.0 is a value determined in advance as the end point of the target range in a case in which the operation mode is the step-up mode. In FIG. 8, the process of Step S400 is represented using “end_val=1.0”. After the process of Step S400 is performed, the range determining unit 231 outputs information representing the start point and the end point of the target range to the counter unit 232 and ends the process of the flowchart illustrated in FIG. 8.

As described above, every time the operation mode is switched, the range determining unit 231 specifies the start point and the end point of the target range and outputs information representing the start point and the end point of the target range that have been specified to the counter unit 232. Since the start point and the end point of the target range are specified in this way, in a case in which the operation mode is to be switched, the control device 20 can linearly change the first duty ratio from a first start point with the first start point set as a start point at which the first duty ratio before operation mode switching is caused to start to change to the first duty ratio after operation mode switching and linearly change the second duty ratio from a second start point with the second start point set as a start point at which the second duty ratio before operation mode switching is caused to start to change to the second duty ratio after operation mode switching. The reason for this can be obtained by understanding the process performed by the counter unit 232 to be described below and the process performed by the signal switching unit 27 to be described below. Hereinafter, for the convenience of description, information that is output to the counter unit 232 by the range determining unit 231 will be referred to as target range information in description. In other words, the target range information is information that represents the start point and the end point of the target range.

### <Process Performed by Counter Unit>

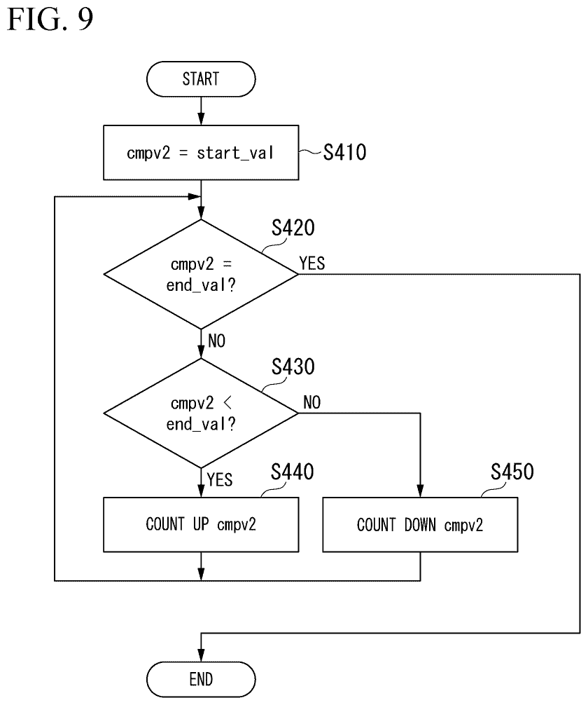

Hereinafter, the process performed by the counter unit 232 will be described with reference to FIG. 9. FIG. 9 is a diagram illustrating one example of the flow of the process performed by the counter unit 232. Hereinafter, for the convenience of description, out of a start point and an end point represented by target range information acquired from the range determining unit 231 at this time, the end point will be referred to as an end point of this time in description.

The counter unit 232 specifies the start point out of the start point and the end point represented by the target range information acquired from the range determining unit 231 at this time as a second comparative value specified at this time (Step S410). Here, in FIG. 9, the start point out of the start point and the end point represented by the target range information acquired from the range determining unit 231 at this time is denoted by start_val, and the second comparative value is denoted by cmpv2. For this reason, in FIG. 9, the process of Step S410 is denoted by “cmpv2=start_val.”

Next, the counter unit 232 determines whether or not the second comparative value specified in Step S410 coincides with the end point of this time (Step S420). Here, in FIG. 9, the end point of this time is denoted by “end_val.” For this reason, in FIG. 9, the process of Step S420 is represented using “cmpv2=end_val?”. In the determination of Step S420, in determining whether or not the second comparative value and the end point of this time coincide with each other, a slight difference determined in advance may be allowed, or this difference may not be allowed. In other words, in the determination of Step S4Be counter unit 232 may be configured to determine that the second comparative value and the end point of this time coincide with each other in a case in which a difference between the second comparative value and the end point of this time is this difference or less and to determine that the second comparative value and the end point of this time do not coincide with each other in a case in which the difference between the second comparative value and the end point of this time exceeds this difference.

In a case in which it is determined that the second comparative value specified in Step S410 and the end point of this time coincide with each other (Step S420—Yes), the counter unit 232 ends the process of the flowchart illustrated in FIG. 9.

On the other hand, in a case in which it is determined that the second comparative value specified in Step S410 and the end point of this time do not coincide with each other (Step S420—No), the counter unit 232 determines whether or not this second comparative value is smaller than the end point of this time (Step S430). In FIG. 9, the process of Step S430 is represented using “cmpv2<end_val.”

In a case in which it is determined that the second comparative value specified in Step S410 is smaller than the end point of this time (Step S430—Yes), the counter unit 232 increases this second comparative value by a change value determined in advance (Step S440). Then, the counter unit 232 outputs a second signal representing the voltage of this second comparative value after the increase by this change value in Step S440 to the second comparison unit 26. Hereinafter, for the convenience of description, this change value will be referred to as a predetermined change value in description. In FIG. 9, the process of Step S440 is represented using “COUNT UP cmpv2”. The predetermined change value, for example, is 0.001 but is not limited thereto. In accordance with such a process of Step S440, the control device 20 can linearly raise the first duty ratio and the second duty ratio with a predetermined change rate in linear change control. For this reason, the predetermined change value can be determined in accordance with a predetermined change rate.

After the process of Step S440 is performed, the counter unit 232 proceeds to Step S420 and determines whether or not the second comparative value after the increase by the predetermined change in Step S440 coincides with the end point of this time.

On the other hand, in a case in which it is determined that the second comparative value specified in Step S410 is the end point of this time or more (Step S430—No), the counter unit 232 decreases this second comparative value by a predetermined change (Step S450). Then, the counter unit 232 outputs a second signal representing the voltage of this second comparative value after the decrease by this change value to the second comparison unit 26. In FIG. 9, the process of Step S450 is represented using “COUNT DOWN cmpv2”. In accordance with the process of such Step S450, the control device 20 can linearly lower the first duty ratio and the second duty ratio with a predetermined change rate in linear change control.

After the process of Step S450 is performed, the counter unit 232 proceeds to Step S420 and determines whether or not the second comparative value after the decrease by the predetermined change in Step S450 coincides with the end point of this time.

In accordance with the process as described above, the counter unit 232 can linearly change the second comparative value from the start point to the end point of the target range determined by the range determining unit 231. As a result, the control device 20 can linearly change the first duty ratio and the second duty ratio with a predetermined change rate in linear change control.

### <Operation of Carrier Signal Generating Unit, First Comparison Unit, and Second Comparison Unit>

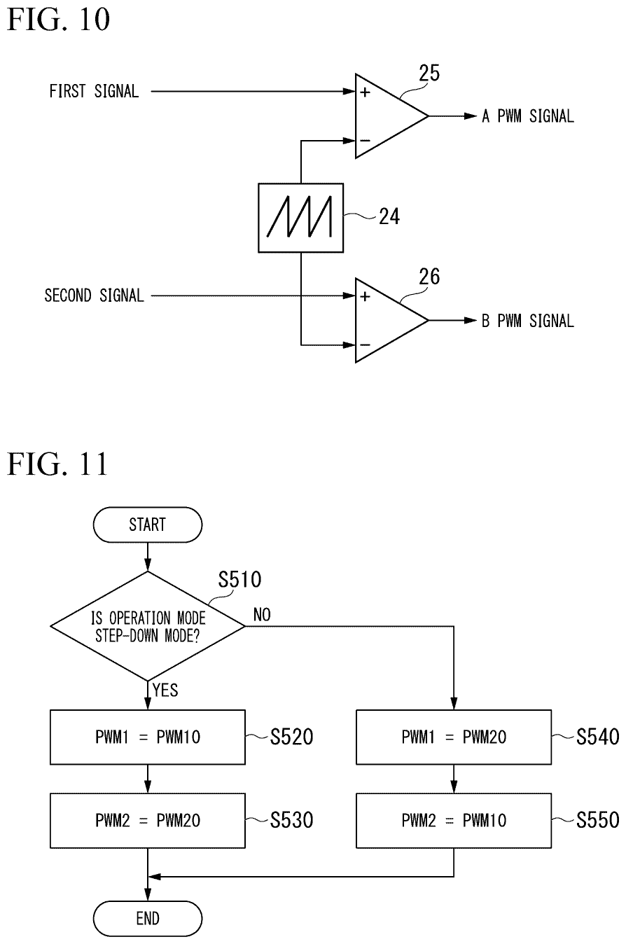

Hereinafter, operations of the carrier signal generating unit 24, the first comparison unit 25, and the second comparison unit 26 will be described with reference to FIG. 10. FIG. 10 is a diagram illustrating a configuration example of each of the first comparison unit 25 and the second comparison unit 26 that output a PWM signal based on a carrier signal generated by the carrier signal generating unit 24.

As illustrated in FIG. 10, each of the first comparison unit 25 and the second comparison unit 26, for example, is a comparator. In FIG. 10, for simplification of the drawing, a positive-side power terminal and a negative-side power terminal of the comparator are omitted.

As described above, by comparing a carrier signal acquired from the carrier signal generating unit 24 with a first signal acquired from the feedback control unit 22, the first comparison unit 25 outputs a A PWM signal to the signal switching unit 27.

On the other hand, as described above, by comparing a carrier signal acquired from the carrier signal generating unit 24 with a second signal acquired from the counter unit 232 of the linear change control unit 23, the second comparison unit 26 outputs a B PWM signal to the signal switching unit 27.

As above, the control device 20 can generate the A PWM signal based on the first signal and the B PWM signal based on the second signal. Then, the control device 20 can switch the output destination of each of the A PWM signal and the B PWM signal in accordance with the operation mode using the signal switching unit 27 described below.

### <Process Performed by Signal Switching Unit>

Hereinafter, the process performed by the signal switching unit 27 will be described with reference to FIG. 11. FIG. 11 is a diagram illustrating one example of the flow of the process performed by the signal switching unit 27.

The signal switching unit 27 determines whether or not the operation mode determined at this time by the operation mode determining unit 21 is the step-down mode based on the operation mode information acquired from the operation mode determining unit 21 (Step S510). In FIG. 11, the process of Step S510 is represented using “IS OPERATION MODE STEP-DOWN MODE?”.

In a case in which it is determined that the operation mode determined at this time by the operation mode determining unit 21 is the step-down mode (Step S510—Yes), the signal switching unit 27 outputs the A PWM signal acquired from the first comparison unit 25 to the first switching element S1 as the first PWM signal (Step S520). In FIG. 11, the A PWM signal is represented using PWM10, and the first PWM signal is represented using PWM1. For this reason, in FIG. 11, the process of Step S520 is represented using “PWM1=PWM10.”

Next, the signal switching unit 27 outputs the B PWM signal acquired from the second comparison unit 26 to the second switching element S2 as the second PWM signal (Step S530). In FIG. 11, the B PWM signal is represented using PWM20, and the second PWM signal is represented using PWM2. For this reason, in FIG. 11, the process of Step S530 is represented using “PWM2=PWM20.” In addition, in the flowchart illustrated in FIG. 11, the process of Step S520 and the process of Step S530 may be performed in reverse order or may be performed in parallel. After the process of Step S530 is performed, the signal switching unit 27 ends the process of the flowchart illustrated in FIG. 11.

On the other hand, in a case in which it is determined that the operation mode determined at this time by the operation mode determining unit 21 is the step-up/down mode or the step-up mode (Step S510—No), the signal switching unit 27 outputs the B PWM signal acquired from the second comparison unit 26 to the first switching element S1 as the first PWM signal (Step S540). In FIG. 11, the process of Step S540 is represented using “PWM1=PWM20.”

Next, the signal switching unit 27 outputs the A PWM signal acquired from the first comparison unit 25 to the second switching element S2 as the second PWM signal (Step S550). In FIG. 11, the process of Step S550 is represented using “PWM2=PWM10.” In addition, in the flowchart illustrated in FIG. 11, the process of Step S540 and the process of Step S550 may be performed in reverse order or may be performed in parallel. After the process of Step S550 is performed, the signal switching unit 27 ends the process of the flowchart illustrated in FIG. 11.

In accordance with the process described above, the signal switching unit 27 switches the output destination of each of two PWM signals in accordance with an operation mode determined at this time by the operation mode determining unit 21. In accordance with this, the control device 20 can change one of the first duty ratio and the second duty ratio through feedback control in accordance with an operation mode and change the other of the first duty ratio and the second duty ratio through linear change control.

In this way, the control device 20 can change one of the first duty ratio and the second duty ratio through feedback control and change the other of the first duty ratio and the second duty ratio through linear change control. In addition, the control device 20 can continuously change the first duty ratio and the second duty ratio at the time of switching the operation mode through feedback control using the feedback control unit 22 and linear change control using the linear change control unit 23. As a result, the control device 20 can inhibit generation of ripples in the input voltage at the time of switching the operation mode of the switching power supply circuit.

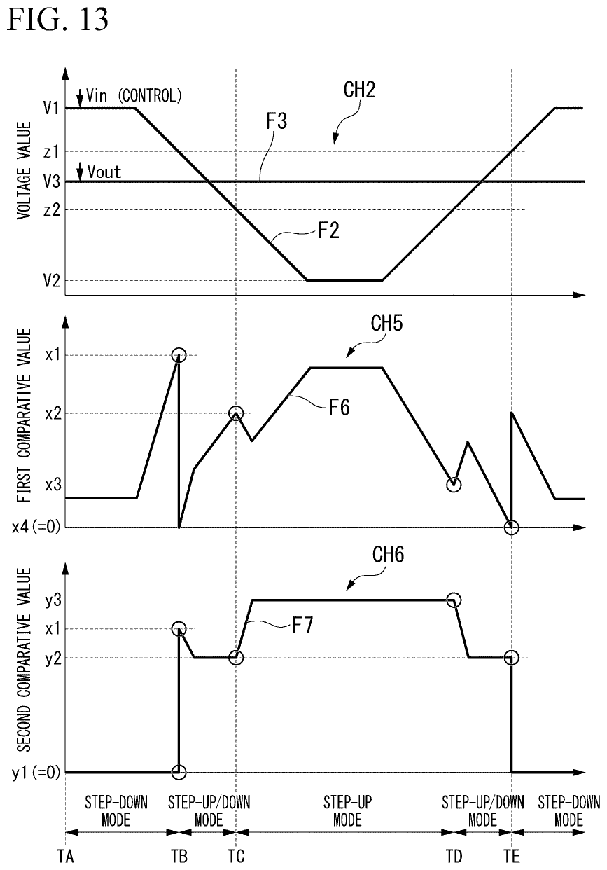

Here, as described above, the signal switching unit 27 switches the output destination of each of two PWM signals in accordance with an operation mode determined at this time by the operation mode determining unit 21. In a case in which a PWM signal output as the first PWM signal is switched from the A PWM signal to the B PWM signal at the time of operation mode switching, in order to cause the first duty ratio to continuously change, the first comparative value of the voltage represented by the first signal after operation mode switching needs to be the second comparative value of the voltage represented by the second signal before operation mode switching. In addition, in a case in which a PWM signal output as the first PWM signal is switched from the B PWM signal to the A PWM signal at the time of operation mode switching, in order to cause the first duty ratio to continuously change, the second comparative value of the voltage represented by the second signal after operation mode switching needs to be the first comparative value of the voltage represented by the first signal before operation mode switching. On the other hand, in a case in which a PWM signal output as the second PWM signal is switched from the A PWM signal to the B PWM signal at the time of operation mode switching, in order to cause the second duty ratio to continuously change, the first comparative value of the voltage represented by the first signal after operation mode switching needs to be the second comparative value of the voltage represented by the second signal before operation mode switching. In addition, in a case in which a PWM signal output as the second PWM signal is switched from the B PWM signal to the A PWM signal at the time of operation mode switching, in order to cause the second duty ratio to continuously change, the second comparative value of the voltage represented by the second signal after operation mode switching needs to be the first comparative value of the voltage represented by the first signal before operation mode switching. The processes of Steps S240 and S270 performed by the feedback control unit 22 and the processes of Steps S340 and S360 performed by the linear change control unit 23 are processes for realizing these. In accordance with such processes, each of the first duty ratio and the second duty ratio can be continuously changed at the time of operation mode switching. However, this represents that a discontinuous change occurs in changes of each of the first comparative value and the second comparative value over time (see FIG. 13). In other words, by suppressing a discontinuous change to the first comparative value and the second comparative value, the control device 20 can inhibit generation of ripples in the input voltage at the time of operation mode switching. The processes of Steps S240 and S270 performed by the feedback control unit 22 and the processes of Steps S340 and S360 performed by the linear change control unit 23 correspond to processes respectively specifying the first start point and the second start point described above.

In addition, the control device 20 may be configured to continuously change the first duty ratio and the second duty ratio at the time of operation mode switching using another configuration instead of the configuration described above. For example, the control device 20 may be configured to continuously change the first duty ratio and the second duty ratio at the time of operation mode switching by employing a configuration in which a processor is included, and the processor outputs a first duty ratio and a second duty ratio in accordance with an operation mode.

As above, in a case in which the operation mode is to be switched, the control device 20 linearly changes the first duty ratio after operation mode switching from the first start point and linearly changes the second duty ratio after operation mode switching from the second start point. In accordance with this, the control device 20 can inhibit generation of ripples in the input voltage at the time of operation mode switching. As a result, the control device 20 can seamlessly switch the operation mode. In addition, since generation of ripples in the input voltage at the time of switching the operation mode can be inhibited, the control device 20 can decrease variations of the input voltage at the time of operation mode switching and, as a result, can inhibit variations of the output voltage as well. This leads to improvement of efficiency for taking out electric power from the solar panel that is the DC power supply P of this example, which is useful. The reason for this is that the control device 20 can inhibit variations of the input voltage at the time of operation mode switching for variations of a target value according to illumination variations (that is, maximum power point tracking) of a case in which the DC power supply P is a solar panel. In addition, the control device 20 can inhibit generation of ripples in the input voltage at the time of switching the operation mode and thus can inhibit application of a load to circuit elements of the switching power supply circuit 10.

### Modified Example 1 of Embodiment

In Modified Example 1 of the embodiment, the operation mode determining unit 21 determines an operation mode based on a first signal and a second signal instead of a configuration in which an operation mode is determined based on an input voltage value and an output voltage value.

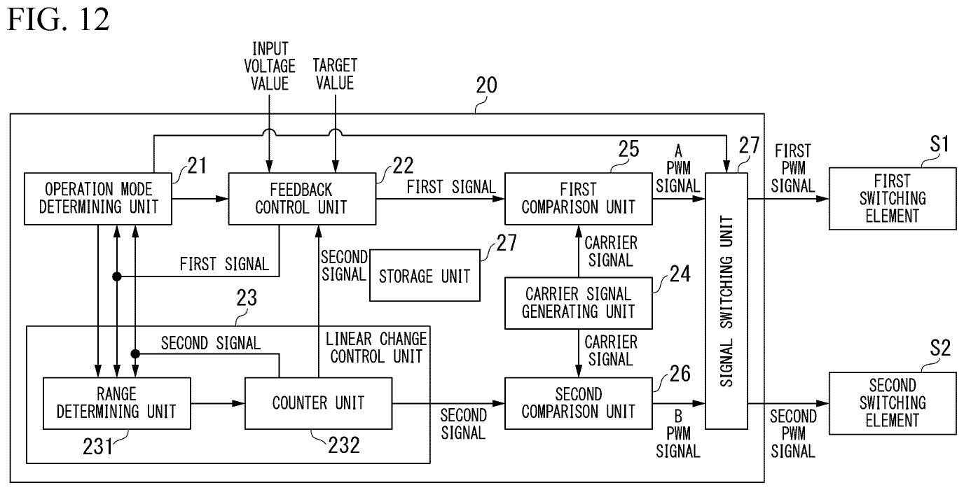

FIG. 12 is a diagram illustrating Modified Example 1 of the configuration of the control device 20. In the example illustrated in FIG. 12, different from the example illustrated in FIG. 4, an input voltage and an output voltage are not input to the operation mode determining unit 21, a first signal is input from the feedback control unit 22, and a second signal is input from the counter unit 232. For this reason, the switching power supply circuit 10 and the control device 20 may be configured not to have the function of an output voltage detecting unit. The configuration of the control device 20 illustrated in FIG. 12 is similar to the configuration of the control device 20 illustrated in FIG. 4 except that inputs/outputs for such an operation mode determining unit 21 are different. For this reason, more detailed description of the configuration of the control device 20 illustrated in FIG. 12 will be omitted.

In Modified Example 1 of the embodiment, the operation mode determining unit 21 determines an operation mode based on a first signal input from the feedback control unit 22 and a second signal input from the counter unit 232. Then, the operation mode determining unit 21 outputs operation mode information indicating an operation mode determined at this time to the feedback control unit 22, the range determining unit 231, and the signal switching unit 27. In addition, the operation mode determining unit 21 reads operation mode information stored at the previous time in the storage unit 28 and outputs the read operation mode information to the feedback control unit 22 and the linear change control unit 23 as previous-time operation mode information indicating an operation mode determined at the previous time by the operation mode determining unit 21. Then, the operation mode determining unit 21 substitutes the operation mode information stored in the storage unit 28 with operation mode information indicating the operation mode determined at this time.

Here, as illustrated in FIG. 2, in a case in which the input voltage value has changed over time, the first comparative value and the second comparative value change over time as illustrated in FIG. 13. FIG. 13 is a diagram illustrating one example of changes of each of the first comparative value and the second comparative value over time in a case in which the input voltage value changes over time as illustrated in FIG. 2.

A timing chart CH2 illustrated in FIG. 13 is a timing chart similar to the timing chart CH2 illustrated in FIG. 2. In other words, also in the example illustrated in FIG. 13, similar to the example illustrated in FIG. 2, the input voltage value changes over time. Here, in a case in which the first duty ratio and the second duty ratio change over time as illustrated in FIG. 2, as represented by a curve F6 of a timing chart CH5 illustrated in FIG. 13, the first comparative value changes over time. The curve F6 drawn in the timing chart CH5 represents changes of the first comparative value over time in this case. In this case, as represented by a curve F7 of a timing chart CH6 illustrated in FIG. 13, the second comparative value changes over time. The curve F7 drawn in the timing chart CH6 represents changes of the second comparative value over time in this case. A horizontal axis of the timing chart CH5 and the timing chart CH6 coincides with the horizontal axis of the timing chart CH2. A vertical axis of the timing chart CH5 represents the first comparative value. In addition, a vertical axis of the timing chart CH6 represents the second comparative value.

Here, when an operation mode is to be determined based on the first comparative value and the second comparative value changing over time as illustrated in FIG. 13, the operation mode determining unit 21 determines the operation mode using values of the first comparative value and the second comparative value at each of timings TB, TC, TD, and TE. In other words, by using seven values of x1 to x4 and y1 to y3 represented in FIG. 13, the operation mode determining unit 21 can determine the operation mode based on the first comparative value and the second comparative value. These seven values, for example, are x1=0.9, x2=0.5, x3=0.2, x4=0.0, y1=0.0, y2=0.7, and y3=1.0 but are not limited thereto.

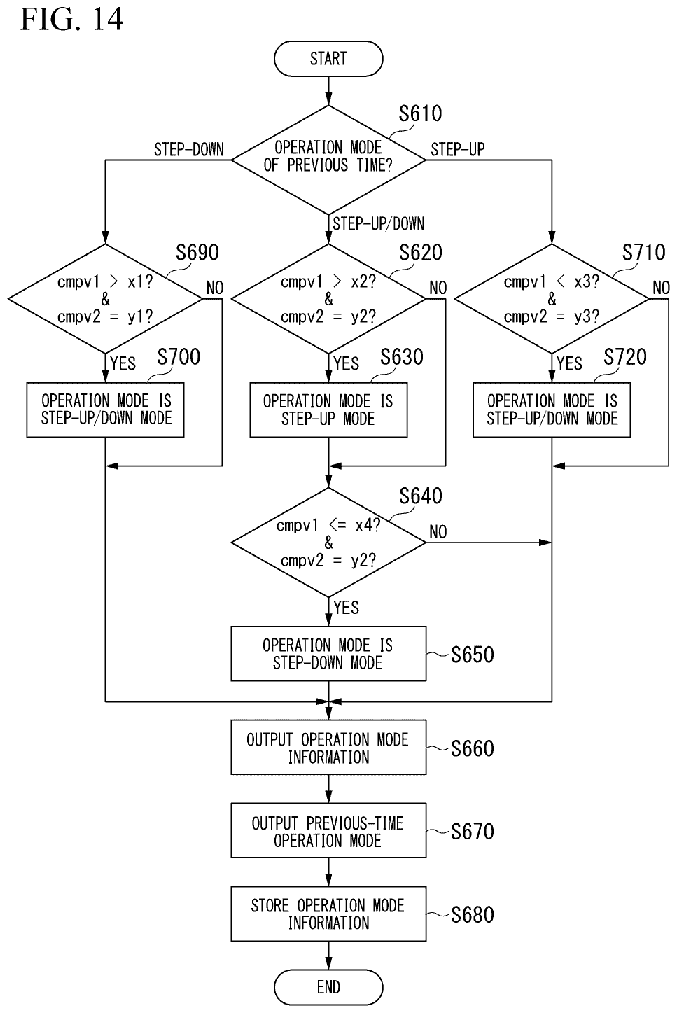

FIG. 14 is a diagram illustrating one example of the flow of a process of the operation mode determining unit 21 determining an operation mode using seven values x1 to x4 and y1 to y3 represented in FIG. 13. Hereinafter, as one example, a case in which information representing these seven values are stored in the storage unit 28 in advance will be described.

The operation mode determining unit 21 reads operation mode information stored at the previous time in the storage unit 28 and determines which one of the step-down mode, the step-up/down mode, and the step-up mode the operation mode determined at the previous time is based on the read operation mode information (Step S610). In FIG. 14, the process of Step S610 is represented using “OPERATION MODE OF PREVIOUS TIME?”.

In a case in which it is determined that the operation mode determined at the previous time is the step-down mode (Step S610—the step-down mode), the operation mode determining unit 21 determines whether or not the first comparative value of the voltage represented by the input first signal is larger than x1, and the second comparative value of the voltage represented by the input second signal coincides with y1 (Step S690). In FIG. 14, the first comparative value is denoted by cmpv1, and the second comparative value is denoted by cmpv2. For this reason, in FIG. 14, the process of Step S690 is represented using “cmpv1>x1 & cmpv2=y1.”

In a case in which it is determined that the first comparative value of the voltage represented by the input first signal is larger than x1, and the second comparative value of the voltage represented by the input second signal coincides with y1 (Step S690—Yes), the operation mode determining unit 21 specifies that the operation mode is the step-up/down mode (Step S700). In this way, in accordance with the processes of Steps S690 and S700, the operation mode determining unit 21 can specify that the operation mode has been switched from the step-down mode to the step-up/down mode at the timing TB. In FIG. 14, the process of Step S700 is represented using “OPERATION MODE IS STEP-UP/DOWN MODE”.

After the process of Step S700 is performed, the operation mode determining unit 21 outputs operation mode information indicating the operation mode specified at this time to the feedback control unit 22, the range determining unit 231 of the linear change control unit 23, and the signal switching unit 27 (Step S660). In FIG. 14, the process of Step S660 is represented using “OUTPUT OPERATION MODE INFORMATION”.

Next, the operation mode determining unit 21 reads the operation mode information stored in the storage unit 28 as previous-time operation mode information indicating an operation mode determined at the previous time and outputs the read previous-time operation mode information to the feedback control unit 22 and the range determining unit 231 (Step S670). In FIG. 14, the process of Step S670 is represented using “OUTPUT PREVIOUS-TIME OPERATION MODE”.

Next, the operation mode determining unit 21 stores operation mode information indicating the operation mode specified at this time in the storage unit 28 (Step S680). Then, the operation mode determining unit 21 ends the process of the flowchart illustrated in FIG. 14. In FIG. 14, the process of Step S680 is represented using “STORE OPERATION MODE INFORMATION”.

In a case in which it is determined that the first comparative value of the voltage represented by the input first signal is x1 or less and/or the second comparative value of the voltage represented by the input second signal does not coincide with y1 (Step S690—No), the operation mode determining unit 21 determines that the operation mode has not been switched, proceeds to Step S660, reads the operation mode information stored in the storage unit 28 as operation mode information indicating the operation mode determined at this time, and outputs the read operation mode information to the feedback control unit 22, the range determining unit 231, and the signal switching unit 27. After the process of Step S660 is performed, the operation mode determining unit 21 proceeds to Step S670, reads the operation mode information stored in the storage unit 28 as previous-time operation mode information indicating an operation mode determined at the previous time, and outputs the read previous-time operation mode information to the feedback control unit 22 and the range determining unit 231. After the process of Step S670 is performed, the operation mode determining unit 21 proceeds to Step S680 and stores operation mode information indicating an operation mode specified at this time in the storage unit 28. In the process of Step S680 of this case, there is no change in the operation mode information stored in the storage unit 28. For this reason, the process of Step S680 of this case may be omitted. After the process of Step S680 is performed, the operation mode determining unit 21 ends the process of the flowchart illustrated in FIG. 14.

On the other hand, in a case in which it is determined that the operation mode determined at the previous time is the step-up/down mode (Step S610—the step-up/down mode), the operation mode determining unit 21 determines whether or not the first comparative value of the voltage represented by the input first signal is larger than x2, and the second comparative value of the voltage represented by the input second signal coincides with y2 (Step S620). In FIG. 14, the process of Step S620 is represented using “cmpv1>x2 & cmpv2=y2.”

In a case in which it is determined that the first comparative value of the voltage represented by the input first signal is larger than x2, and the second comparative value of the voltage represented by the input second signal coincides with y2 (Step S620—Yes), the operation mode determining unit 21 specifies that the operation mode is the step-up mode (Step S630). In this way, in accordance with the processes of Steps S620 and S630, the operation mode determining unit 21 can specify that the operation mode has been switched from the step-up/down mode to the step-up mode at the timing TC. In FIG. 14, the process of Step S630 is represented using “OPERATION MODE IS STEP-UP MODE”.

After the process of Step S630 is performed, the operation mode determining unit 21 determines whether or not the first comparative value of the voltage represented by the input first signal is x4 or less, and the second comparative value of the voltage represented by the input second signal coincides with y2 (Step S640). In FIG. 14, the process of Step S640 is represented using “cmpv1<=x4 & cmpv2=y2.”

In a case in which it is determined that the first comparative value of the voltage represented by the input first signal is x4 or less, and the second comparative value of the voltage represented by the input second signal coincides with y2 (Step S640—Yes), the operation mode determining unit 21 specifies that the operation mode is the step-down mode (Step S650). In FIG. 14, the process of Step S650 is represented using “OPERATION MODE IS STEP-DOWN MODE”. In this way, in accordance with processes of Steps S640 and S650, the operation mode determining unit 21 can specify that the operation mode has been switched from the step-up/down mode to the step-down mode at the timing TE. In addition, in a case in which it is determined that the operation mode is the step-up mode in Steps S620 and S630, the operation mode determining unit 21 determines that the first comparative value of the voltage represented by the input first signal is x4 or more, and the second comparative value of the voltage represented by the input second signal does not coincide with y2 in the process of Step S640. For this reason, the operation mode determining unit 21 is configured not to perform the process of Step S630 and the process of Step S650 at the same time in the operation of each time.

Next, the operation mode determining unit 21 proceeds to Step S660 and outputs operation mode information indicating the operation mode specified at this time in Step S650 to the feedback control unit 22, the range determining unit 231 of the linear change control unit 23, and the signal switching unit 27. After the process of Step S660 is performed, the operation mode determining unit 21 proceeds to Step S670, reads the operation mode information stored in the storage unit 28 as previous-time operation mode information indicating an operation mode determined at the previous time, and outputs the read previous-time operation mode information to the feedback control unit 22 and the range determining unit 231. After the process of Step S670 is performed, the operation mode determining unit 21 proceeds to Step S680 and stores operation mode information indicating the operation mode specified at this time in the storage unit 28. Then, the operation mode determining unit 21 ends the process of the flowchart illustrated in FIG. 14.

On the other hand, in a case in which it is determined that the first comparative value of the voltage represented by the input first signal is larger than x4, and/or the second comparative value of the voltage represented by the input second signal does not coincide with y2 (Step S640—No), the operation mode determining unit 21 proceeds to Step S660 and outputs the operation mode information indicating the operation mode specified at this time in Step S630 to the feedback control unit 22, the range determining unit 231 of the linear change control unit 23, and the signal switching unit 27. After the process of Step S660 is performed, the operation mode determining unit 21 proceeds to Step S670, reads the operation mode information stored in the storage unit 28 as previous-time operation mode information indicating the operation mode determined at the previous time, and outputs the read previous-time operation mode information to the feedback control unit 22 and the range determining unit 231. After the process of Step S670 is performed, the operation mode determining unit 21 proceeds to Step S680 and stores the operation mode information indicating the operation mode specified at this time in the storage unit 28. Then, the operation mode determining unit 21 ends the process of the flowchart illustrated in FIG. 14.

On the other hand, in a case in which it is determined that the first comparative value of the voltage represented by the input first signal is x2 or less, and/or the second comparative value of the voltage represented by the input second signal does not coincide with y2 (Step S620—No), the operation mode determining unit 21 proceeds to Step S640 and determines whether or not the first comparative value of the voltage represented by the input first signal is x4 or less, and the second comparative value of the voltage represented by the input second signal coincides with y2.

On the other hand, in a case in which it is determined that the operation mode determined at the previous time is the step-up mode (Step S610—the step-up mode), the operation mode determining unit 21 determines whether or not the first comparative value of the voltage represented by the input first signal is larger than x3, and the second comparative value of the voltage represented by the input second signal coincides with y3 (Step S710). In FIG. 14, the first comparative value is denoted by cmpv1, and the second comparative value is denoted by cmpv2. For this reason, in FIG. 14, the process of Step S690 is represented using “cmpv1<x3 & cmpv2=y3.”

In a case in which the first comparative value of the voltage represented by the input first signal is larger than x3, and the second comparative value of the voltage represented by the input second signal coincides with y3 (Step S710—Yes), the operation mode determining unit 21 specifies that the operation mode is the step-up/down mode (Step S720). In this way, in accordance with the processes of Steps S710 and S7Be operation mode determining unit 21 can specify that the operation mode has been switched from the step-up mode to the step-up/down mode at the timing TD. In FIG. 14, the process of Step S720 is represented using “OPERATION MODE IS STEP-UP/DOWN MODE”.

After the process of Step S720 is performed, the operation mode determining unit 21 proceeds to Step S660 and outputs the operation mode information indicating the operation mode specified at this time in Step S720 to the feedback control unit 22, the range determining unit 231 of the linear change control unit 23, and the signal switching unit 27. After the process of Step S660 is performed, the operation mode determining unit 21 proceeds to Step S670, reads the operation mode information stored in the storage unit 28 as previous-time operation mode information indicating an operation mode determined at the previous time, and outputs the read previous-time operation mode information to the feedback control unit 22 and the range determining unit 231. After the process of Step S670 is performed, the operation mode determining unit 21 proceeds to Step S680 and stores operation mode information indicating the operation mode specified at this time in the storage unit 28. Then, the operation mode determining unit 21 ends the process of the flowchart illustrated in FIG. 14.

On the other hand, in a case in which it is determined that the first comparative value of the voltage represented by the input first signal is x3 or less, and/or the second comparative value of the voltage represented by the input second signal does not coincide with y3 (Step S710—No), the operation mode determining unit 21 determines that the operation mode has not been switched, proceeds to Step S660, reads the operation mode information stored in the storage unit 28 as operation mode information indicating the operation mode determined at this time, and outputs the read operation mode information to the feedback control unit 22, the range determining unit 231, and the signal switching unit 27. After the process of Step S660 is performed, the operation mode determining unit 21 proceeds to Step S670, reads the operation mode information stored in the storage unit 28 as previous-time operation mode information indicating the operation mode determined at the previous time, and outputs the read previous-time operation mode information to the feedback control unit 22 and the range determining unit 231. After the process of Step S670 is performed, the operation mode determining unit 21 proceeds to Step S680 and stores the operation mode information indicating the operation mode specified at this time in the storage unit 28. In the process of Step S680 of this case, there is no change in the operation mode information stored in the storage unit 28. For this reason, the process of Step S680 of this case may be omitted. After the process of Step S680 is performed, the operation mode determining unit 21 ends the process of the flowchart illustrated in FIG. 14.

As described above, the operation mode determining unit 21 can determine an operation mode based on the first signal and the second signal in place of the configuration determining an operation mode based on an input voltage value and an output voltage value. In this case, the control device 20 can cause the switching power supply circuit 10 to perform an operation of each operation mode in accordance with a maximum duty ratio or a minimum duty ratio set as the first duty ratio and the second duty ratio regardless of changes of the input voltage value and the output voltage value. This, compared to a case in which the operation mode determining unit 21 determines an operation mode based on the input voltage value and the output voltage value, leads to a stable operation of the switching power supply circuit 10 in a broader range, which is useful. However, in a case in which the operation mode determining unit 21 determines an operation mode based on the input voltage value and the output voltage value, the control device 20 can quicken the response compared to a case in which the operation mode determining unit 21 determines an operation mode based on the first signal and the second signal.

In addition, the operation mode determining unit 21 may be configured to perform switching between determination of an operation mode using the input voltage value and the output voltage value and determination of an operation mode using the first signal and the second signal in accordance with situations. For example, the operation mode determining unit 21 may be configured to perform determination of an operation mode using the input voltage value and the output voltage value at the time of a first-time operation and perform determination of an operation mode using the first signal and the second signal at the time of a second operation and subsequent operations. In accordance with this, the control device 20 can operate the switching power supply circuit 10 more stably.

### Modified Example 2 of Embodiment

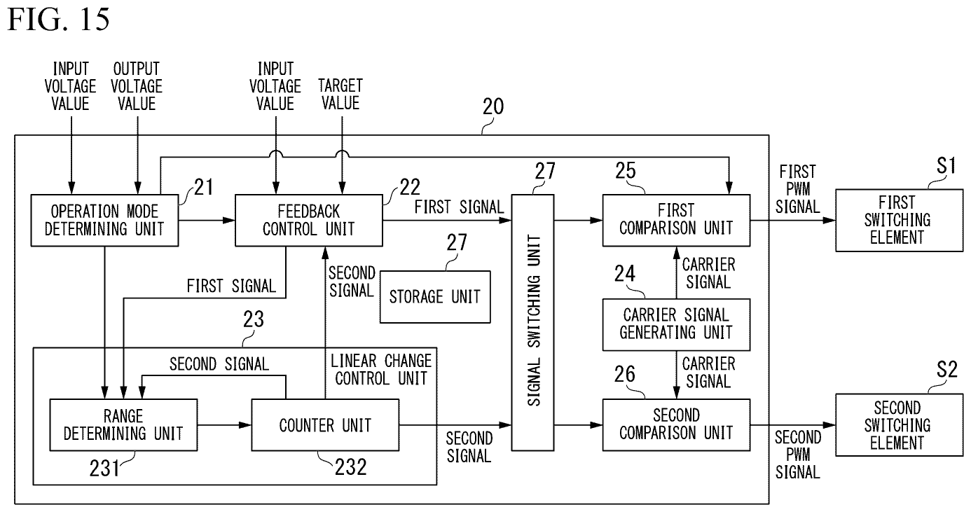

FIG. 15 is a diagram illustrating Modified Example 2 of the configuration of the control device 20. In Modified Example 2 of the embodiment, as illustrated in FIG. 15, the signal switching unit 27 is disposed between the feedback control unit 22 and the first comparison unit 25 and between the linear change control unit 23 and the second comparison unit 26. In other words, in Modified Example 2 of the embodiment, the signal switching unit 27 is disposed on the previous stage of the first comparison unit 25 and the second comparison unit 26. For this reason, in Modified Example 2 of the embodiment, the feedback control unit 22 outputs a first signal to the signal switching unit 27. In addition, in Modified Example 2 of the embodiment, the counter unit 232 outputs a second signal to the signal switching unit 27.

In a case in which an operation mode determined at this time by the operation mode determining unit 21 is specified to be the step-down mode, the signal switching unit 27 outputs the first signal acquired from the feedback control unit 22 to the first comparison unit 25 as a A signal and outputs a second signal acquired from the linear change control unit 23 to the second comparison unit 26 as a B signal. In addition, in a case in which the operation mode determined at this time by the operation mode determining unit 21 is specified to be the step-up/down mode or the step-up mode, the signal switching unit 27 outputs the first signal acquired from the feedback control unit 22 to the second comparison unit 26 as the A signal and outputs the second signal acquired from the linear change control unit 23 to the first comparison unit 25 as the B signal.

In a case in which the A signal is acquired from the signal switching unit 27, the first comparison unit 25 generates a PWM signal according to comparison between the acquired A signal and a carrier signal as a first PWM signal and inputs the generated first PWM signal to the first switching element S1. On the other hand, in a case in which the B signal is acquired from the signal switching unit 27, the first comparison unit 25 generates a PWM signal according to comparison between the acquired B signal and a carrier signal as a first PWM signal and inputs the generated first PWM signal to the first switching element S1.

In a case in which the A signal is acquired from the signal switching unit 27, the second comparison unit 26 generates a PWM signal according to comparison between the acquired A signal and a carrier signal as a second PWM signal and inputs the generated second PWM signal to the second switching element S2. On the other hand, in a case in which the B signal is acquired from the signal switching unit 27, the second comparison unit 26 generates a PWM signal according to comparison between the acquired B signal and a carrier signal as a second PWM signal and inputs the generated second PWM signal to the second switching element S2.

In Modified Example 2 of the embodiment, the configuration of the control device 20 is similar to the configuration of the control device 20 illustrated in FIG. 5 except the items described above. For this reason, more detailed description of the configuration of the control device 20 illustrated in FIG. 15 will be omitted.

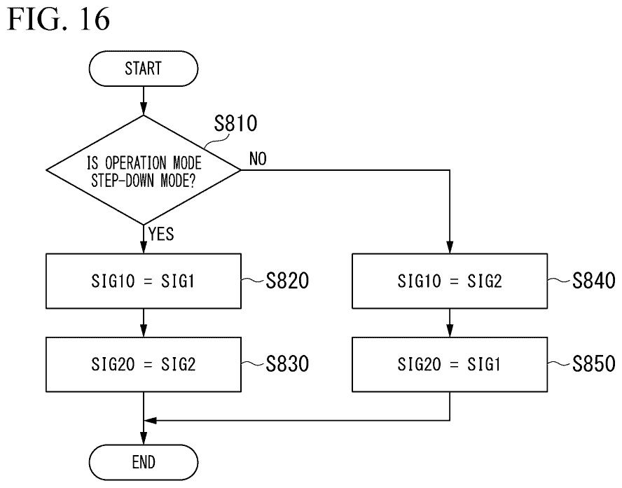

FIG. 16 is a diagram illustrating a modified example of the flow of a process performed by the signal switching unit 27.

The signal switching unit 27 determines whether or not the operation mode determined at this time by the operation mode determining unit 21 is the step-down mode based on the operation mode information acquired from the operation mode determining unit 21 (Step S810). In FIG. 16, the process of Step S810 is represented using “IS OPERATION MODE STEP-DOWN MODE?”.

In a case in which it is determined that the operation mode determined at this time by the operation mode determining unit 21 is the step-down mode (Step S810—Yes), the signal switching unit 27 outputs the first signal acquired from the feedback control unit 22 to the first comparison unit 25 as a A signal (Step S820). In FIG. 16, the first signal is denoted by SIG1, and the A signal is denoted by SIG10. For this reason, in FIG. 16, the process of Step S820 is represented using “SIG10=SIG1.”

Next, the signal switching unit 27 outputs the second signal acquired from the counter unit 232 to the second comparison unit 26 as a B signal (Step S830). In FIG. 16, the second signal is denoted by SIG2, and the B signal is denoted by SIG20. For this reason, in FIG. 16, the process of Step S830 is represented using “SIG20=SIG2.” In addition, in the flowchart illustrated in FIG. 16, the process of Step S820 and the process of Step S830 may be performed in reverse order or may be performed in parallel. After the process of Step S830 is performed, the signal switching unit 27 ends the process of the flowchart illustrated in FIG. 16.

On the other hand, in a case in which it is determined that the operation mode determined at this time by the operation mode determining unit 21 is the step-up/down mode or the step-up mode (Step S810—No), the signal switching unit 27 outputs the second signal acquired from the counter unit 232 to the first comparison unit 25 as the A signal (Step S840). In FIG. 16, the process of Step S840 is represented using “SIG10=SIG2.”

Next, the signal switching unit 27 outputs the first signal acquired from the feedback control unit 22 to the second comparison unit 26 as the B signal (Step S850). In FIG. 16, the process of Step S850 is represented using “SIG20=SIG1.” In addition, in the flowchart illustrated in FIG. 16, the process of Step S840 and the process of Step S850 may be performed in reverse order or may be performed in parallel. After the process of Step S850 is performed, the signal switching unit 27 ends the process of the flowchart illustrated in FIG. 16.

As above, also in a case in which the signal switching unit 27 is disposed on the previous stage of the first comparison unit 25 and the second comparison unit 26, the control device 20 can switch an output destination of each of two PWM signals in accordance with an operation mode determined at this time by the operation mode determining unit 21. In accordance with this, the control device 20 can change one of the first duty ratio and the second duty ratio in accordance with an operation mode through feedback control and change the other of the first duty ratio and the second duty ratio through linear change control.

### Modified Example 3 of Embodiment

In Modified Example 3 of the embodiment, similar to the embodiment, the operation mode determining unit 21 performs determination of an operation mode using an input voltage value and an output voltage value. However, in Modified Example 3 of the embodiment, different from the embodiment, the operation mode determining unit 21 has hysteresis. In other words, in Modified Example 3 of the embodiment, the operation mode determining unit 21 changes at least one of an upper-limit voltage value z1 and a lower-limit voltage value z2 at the time of switching the operation mode. In accordance with this, the control device 20 can improve stability of the operation of the switching power supply circuit 10 at the time of operation mode switching. Hereinafter, as one example, a case in which the operation mode determining unit 21 changes one of the upper-limit voltage value z1 and the lower-limit voltage value z2 at the time of switching the operation mode will be described.

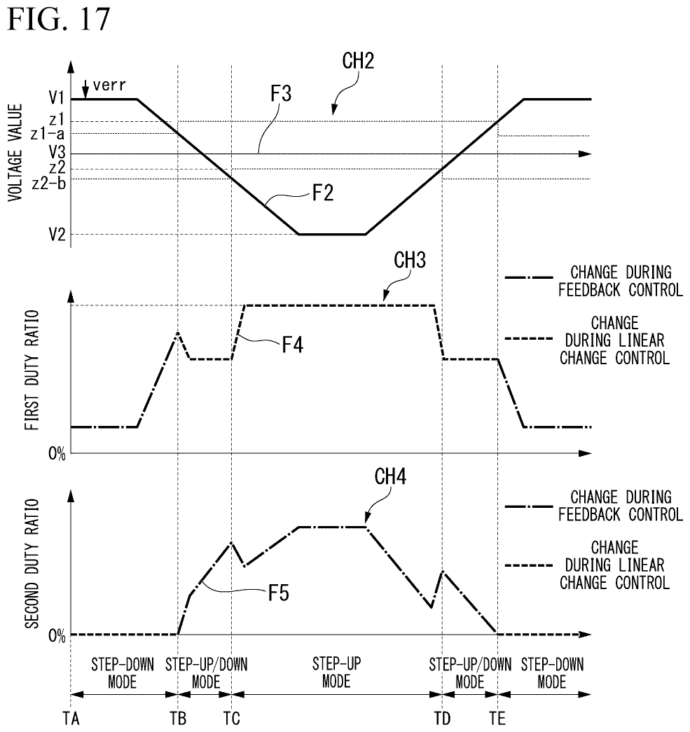

For example, as illustrated in FIG. 17, the operation mode determining unit 21 changes each of the upper-limit voltage value z1 and the lower-limit voltage value z2. FIG. 17 is a diagram explaining the operation mode determining unit 21 changing each of the upper-limit voltage value z1 and the lower-limit voltage value z2. In FIG. 17, the timing charts CH2 to CH4 illustrated in FIG. 2 are illustrated. As illustrated in FIG. 17, the operation mode determining unit 21 uses an upper-limit voltage value z1 as an upper-limit voltage value under the step-up/down mode and the step-up mode. On the other hand, the operation mode determining unit 21 uses an upper-limit voltage value z1-a as an upper-limit voltage value under the step-down mode. Here, a may have any value and, for example, is a value of 10% of the upper-limit voltage value z1 but is not limited thereto. In addition, the operation mode determining unit 21 uses a lower-limit voltage value z2 as a lower-limit voltage value under the step-up mode. On the other hand, the operation mode determining unit 21 uses a lower-limit voltage value z2-b as a lower-limit voltage value under the step-down mode and the step-up/down mode. Here, b may have any value and, for example, is a value of 10% of the lower-limit voltage value z2 but is not limited thereto.

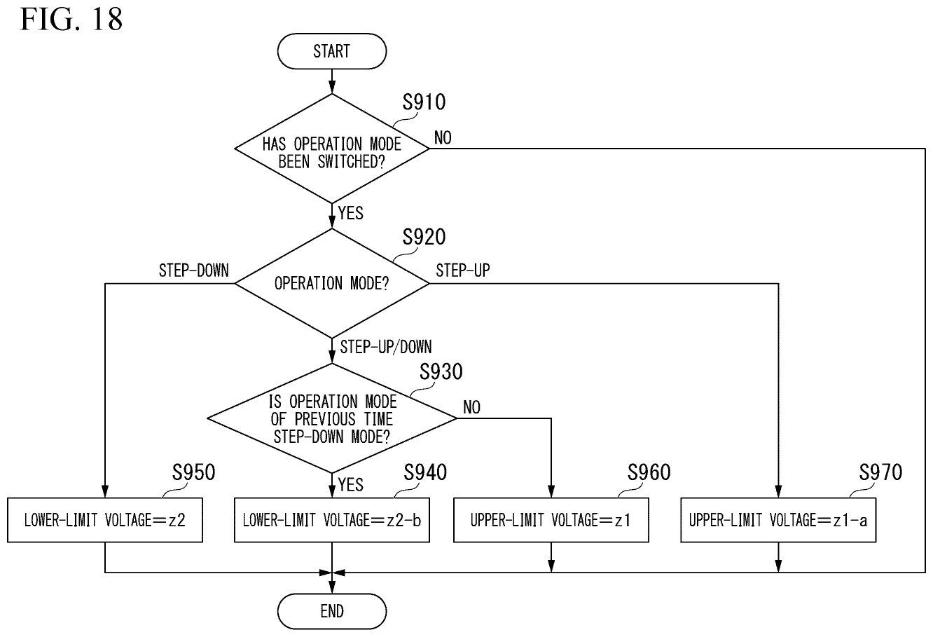

In this way, the operation mode determining unit 21 changes one of the upper-limit voltage value and the lower-limit voltage value at the time of switching the operation mode. More specifically, in accordance with the process of a flowchart illustrated in FIG. 18, the operation mode determining unit 21 changes one of the upper-limit voltage value and the lower-limit voltage value at the time of switching the operation mode.

FIG. 18 is a diagram illustrating one example of the flow of a process of the operation mode determining unit 21 changing an upper-limit voltage value and a lower-limit voltage value. Hereinafter, as one example, a case in which, at the time of a first-time operation of the operation mode determining unit 21, an upper-limit voltage value is the upper-limit voltage value z1, and a lower-limit voltage value is the lower-limit voltage value z2 will be described. Here, the upper-limit voltage value and the lower-limit voltage value at the time of the first-time operation of the operation mode determining unit 21 may be different values.

The operation mode determining unit 21 determines whether or not the operation mode has been switched based on input operation mode information and input previous-time operation mode information (Step S910). More specifically, in a case in which an operation mode indicated by this operation mode information and an operation mode indicated by this previous-time operation mode information coincide with each other, the operation mode determining unit 21 determines that the operation mode has not been switched. On the other hand, in a case in which an operation mode indicated by this operation mode information and an operation mode indicated by this previous-time operation mode information do not coincide with each other, the operation mode determining unit 21 determines that the operation mode has been switched. In FIG. 18, the process of Step S910 is represented using “HAS OPERATION MODE BEEN SWITCHED?”.

In a case in which it is determined that the operation mode has not been switched (Step S910—No), the operation mode determining unit 21 ends the process of the flowchart illustrated in FIG. 18 without performing any operation.

On the other hand, in a case in which it is determined that the operation mode has been switched (Step S910—Yes), the operation mode determining unit 21 determines which one of the step-down mode, the step-up/down mode, and the step-up mode the operation mode after switching is based on the input operation mode information (Step S920). In FIG. 18, the process of Step S920 is represented using “OPERATION MODE?”.

In a case in which it is determined that the operation mode after switching is the step-down mode (Step S920—the step-down mode), the operation mode determining unit 21 sets the lower-limit voltage value to the lower-limit voltage value z2 (Step S950) and ends the process of the flowchart illustrated in FIG. 18. In FIG. 18, the process of Step S950 is represented using “LOWER-LIMIT VOLTAGE=z2”.

On the other hand, in a case in which it is determined that the operation mode after switching is the step-up/down mode (Step S920—the step-up/down mode), the operation mode determining unit 21 determines whether or not the operation mode before switching is the step-down mode based on the previous-time operation mode information (Step S930). In FIG. 18, the process of Step S930 is represented using “IS OPERATION MODE OF PREVIOUS TIME STEP-DOWN MODE?”.

In a case in which it is determined that the operation mode before switching is the step-down mode (Step S930—Yes), the operation mode determining unit 21 sets the lower-limit voltage value to the lower-limit voltage value z2-b (Step S940) and ends the process of the flowchart illustrated in FIG. 18. In FIG. 18, the process of Step S940 is represented using “LOWER-LIMIT VOLTAGE=z2-b”.

On the other hand, in a case in which it is determined that the operation mode before switching is not the step-down mode (Step S930—No), the operation mode determining unit 21 sets the upper-limit voltage value to an upper-limit voltage value z1 (Step S960) and ends the process of the flowchart illustrated in FIG. 18. In FIG. 18, the process of Step S960 is represented using “UPPER-LIMIT VOLTAGE=z1”.

In addition, in a case in which it is determined that the operation mode after switching is the step-up mode (Step S920—the step-up mode), the operation mode determining unit 21 sets the upper-limit voltage value to an upper-limit voltage value z1-a (Step S970) and ends the process of the flowchart illustrated in FIG. 18. In FIG. 18, the process of Step S970 is represented using “UPPER-LIMIT VOLTAGE=z1-a”.

As above, the operation mode determining unit 21 changes one of the upper-limit voltage value and the lower-limit voltage value at the time of switching the operation mode. In other words, the operation mode determining unit 21 has hysteresis. In accordance with this, the control device 20 can improve stability of the operation of the switching power supply circuit 10 at the time of operation mode switching.

The matters described above may be combined in any manner.

### <Supplement>

[1]

A control device controlling a switching power supply circuit including a first switching element and a second switching element, wherein the control device operates the switching power supply circuit in accordance with an operation mode according to a difference between a voltage value of an input voltage for the switching power supply circuit and a voltage value of an output voltage from the switching power supply circuit, the control device linearly changes a duty ratio in PWM (Pulse Width Modulation) control of the first switching element from a first start point, and linearly changes a duty ratio in PWM control of the second switching element from a second start point, in a case in which the operation mode operating the switching power supply circuit is to be switched, the first start point is a duty ratio in PWM control of the first switching element before the operation mode switching set as a start point at which a duty ratio in PWM control of the first switching element after the operation mode switching to be changed, the second start point is a duty ratio in PWM control of the second switching element before the operation mode switching set as the second start point at which a duty ratio in PWM control of the second switching element after the operation mode switching starts to be changed.

[2]

The control device described in [1], in which the switching power supply circuit includes: a first side including a first upper arm and a first lower arm of an H bridge; a second side including a second upper arm and a second lower arm of the H bridge; a coil joining a first connection point between the first upper arm and the first lower arm on the first side and a second connection point between the second upper arm and the second lower arm on the second side; the first switching element disposed in the first upper arm; a first current limiting unit disposed in the first lower arm and limiting a direction of a current from the first lower arm side to the first upper arm side; a second current limiting unit disposed in the second upper arm and limiting a direction of a current from the second lower arm side to the second upper arm side; and the second switching element disposed in the second lower arm.

[3]

The control device described in [2], in which the control device, in a case in which the operation mode is switched from a first mode to a second mode, changes the duty ratio of the first switching element after the operation mode switching from the first start point through feedback control and changes the duty ratio of the second switching element after the operation mode switching from the second start point through linear change control, and, in a case in which the operation mode is switched from the second mode to the first mode, changes the duty ratio of the first switching element after the operation mode switching from the first start point through the linear change control and changes the duty ratio of the second switching element after the operation mode switching from the second start point through the feedback control, and the linear change control is control linearly changing a duty ratio.

[4]

The control device described in [3], in which the switching power supply circuit or the control device includes: an input voltage detecting unit detecting the voltage value of the input voltage input between the first upper arm and the first lower arm; and an output voltage detecting unit detecting the voltage value of the output voltage output between the second upper arm and the second lower arm, the control device comprises: an operation mode determining unit determining the operation mode; a carrier signal generating unit generating a carrier signal of a PWM signal; a feedback control unit outputting a first signal to be compared with the carrier signal for generating PWM signals in feedback control for a duty ratio in PWM control of the first switching element and feedback control for a duty ratio in PWM control of the second switching element; a linear change control unit outputting a second signal to be compared with the carrier signal for generating PWM signals in the linear change control for the duty ratio in PWM control of the first switching element and the linear change control for the duty ratio in PWM control of the second switching element; a first comparison unit generating a PWM signal according to comparison between the first signal and the carrier signal as a A PWM signal; a second comparison unit generating a PWM signal according to comparison between the second signal and the carrier signal as a B PWM signal; and a signal switching unit inputting the A PWM signal generated by the first comparison unit to the first switching element as a first PWM signal and inputting the B PWM signal generated by the second comparison unit to the second switching element as a second PWM signal in a case in which the operation mode is determined to be the first mode by the operation mode determining unit, and inputting the B PWM signal generated by the second comparison unit to the first switching element as the first PWM signal and inputting the A PWM signal generated by the first comparison unit to the first switching element as the first PWM signal in a case in which the operation mode is determined to be the second mode by the operation mode determining unit, the feedback control unit outputs the first signal through feedback control based on the voltage value of the input voltage detected by the input voltage detecting unit, a target value of the voltage value of the input voltage, and the second signal output by the linear change control unit, and the linear change control unit includes: a range determining unit determining a range in which the second signal is changed based on the operation mode determined by the operation mode determining unit, the first signal output by the feedback control unit, and the second signal output at the previous time every time the operation mode is switched; and a counter unit outputting the second signal every time a voltage value of a voltage represented by the second signal is changed with a change rate determined in advance from a start point to an end point of the range determined by the range determining unit.

[5]

The control device described in [4], in which the operation mode determining unit determines which one of the first mode and the second mode the operation mode is based on the voltage value of the input voltage detected by the input voltage detecting unit and the voltage value of the output voltage detected by the output voltage detecting unit.

[6]

The control device described in [4], in which the operation mode determining unit determines which one of the first mode and the second mode the operation mode is based on the first signal output from the feedback control unit and the second signal output from the linear change control unit.

[7]

The control device described in [4], in which the operation mode determining unit determines which one of the first mode and the second mode the operation mode is based on the voltage value of the input voltage detected by the input voltage detecting unit and the voltage value of the output voltage detected by the output voltage detecting unit at the time of a first-time operation of the control device and, thereafter, determines which one of the first mode and the second mode the operation mode is based on the first signal output from the feedback control unit and the second signal output from the linear change control unit.

[8]

The control device described in [4], further including a storage unit storing information representing each of the operation mode determined at this time by the operation mode determining unit and the operation mode determined at the previous time by the operation mode determining unit.

[9]

The control device described in any one of [3] to [8], in which the first mode is a step-down mode, and the second mode is a step-up/down mode or a step-up mode.

[10]

The control device described in [5], in which the operation mode determining unit has hysteresis.

[11]

The control device described in any one of [2] to [10], in which a power supply inputting the input voltage between the first upper arm and the first lower arm is a solar panel.

[12]

A switching power supply circuit including a first switching element and a second switching element, wherein the switching power supply circuit is operated in accordance with an operation mode according to a difference between a voltage value of an input voltage for the switching power supply circuit and a voltage value of an output voltage from the switching power supply circuit, the switching power supply circuit linearly changes a duty ratio in PWM (Pulse Width Modulation) control of the first switching element from a first start point, and linearly changes a duty ratio in PWM control of the second switching element from a second start point, in a case in which the operation mode operating the switching power supply circuit is to be switched, the first start point is a duty ratio in PWM control of the first switching element before the operation mode switching set as a start point at which a duty ratio in PWM control of the first switching element after the operation mode switching to be changed, the second start point is a duty ratio in PWM control of the second switching element before the operation mode switching set as the second start point at which a duty ratio in PWM control of the second switching element after the operation mode switching starts to be changed.

[13]

A control method controlling a switching power supply circuit including a first switching element and a second switching element, the control method including: operating the switching power supply circuit in accordance with an operation mode according to a difference between a voltage value of an input voltage for the switching power supply circuit and a voltage value of an output voltage from the switching power supply circuit; and linearly changing a duty ratio in PWM (Pulse Width Modulation) control of the first switching element from a first start point, and linearly changing a duty ratio in PWM control of the second switching element from a second start point, in a case in which the operation mode operating the switching power supply circuit is to be switched, the first start point is a duty ratio in PWM control of the first switching element before the operation mode switching set as a start point at which a duty ratio in PWM control of the first switching element after the operation mode switching to be changed, the second start point is a duty ratio in PWM control of the second switching element before the operation mode switching set as the second start point at which a duty ratio in PWM control of the second switching element after the operation mode switching starts to be changed.

As above, while the embodiment of the present disclosure has been described in detail with reference to the drawings, a specific configuration is not limited to this embodiment, and modifications, substitutions, omissions, and the like may be applied as long as it does not depart from the concept of the present disclosure.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

1 Switching power supply device
10 Switching power supply circuit
20 Control device
21 Operation mode determining unit
22 Feedback control unit
23 Linear change control unit
24 Carrier signal generating unit
25 First comparison unit
26 Second comparison unit
27 Signal switching unit
28 Storage unit
231 Range determining unit
232 Counter unit
AD1 First lower arm
AD2 Second lower arm
AU1 First upper arm
AU2 Second upper arm
C1 Capacitor
C2 Capacitor
CL Coil
CN1 First connection point
CN2 Second connection point
D1 First current limiting unit
D2 Second current limiting unit
LD Load
P DC power supply
R11 Resistance element
R12 Resistance element
R21 Resistance element
R22 Resistance element
S1 First switching element
S2 Second switching element

What is claimed is:

1. A control device controlling a switching power supply circuit comprising a first switching element and a second switching element,
wherein the control device operates the switching power supply circuit in accordance with an operation mode according to a difference between a voltage value of an input voltage for the switching power supply circuit and a voltage value of an output voltage from the switching power supply circuit,
the control device linearly changes a duty ratio in PWM (Pulse Width Modulation) control of the first switching element from a first start point, and linearly changes a duty ratio in PWM control of the second switching element from a second start point, in a case in which the operation mode operating the switching power supply circuit is to be switched,
the first start point is a duty ratio in PWM control of the first switching element before the operation mode switching set as a start point at which a duty ratio in PWM control of the first switching element after the operation mode switching to be changed,
the second start point is a duty ratio in PWM control of the second switching element before the operation mode switching set as the second start point at which a duty ratio in PWM control of the second switching element after the operation mode switching starts to be changed.

2. The control device according to claim 1, wherein the switching power supply circuit includes:
a first side including a first upper arm and a first lower arm of an H bridge;
a second side including a second upper arm and a second lower arm of the H bridge;
a coil joining a first connection point between the first upper arm and the first lower arm on the first side and a second connection point between the second upper arm and the second lower arm on the second side;
the first switching element disposed in the first upper arm;
a first current limiting unit disposed in the first lower arm and limiting a direction of a current from the first lower arm side to the first upper arm side;
a second current limiting unit disposed in the second upper arm and limiting a direction of a current from the second lower arm side to the second upper arm side; and
the second switching element disposed in the second lower arm.

3. The control device according to claim 2,
wherein the control device, in a case in which the operation mode is switched from a first mode to a second mode, changes the duty ratio of the first switching element after the operation mode switching from the first start point through feedback control and changes the duty ratio of the second switching element after the operation mode switching from the second start point through linear change control, and, in a case in which the operation mode is switched from the second mode to the first mode, changes the duty ratio of the first switching element after the operation mode switching from the first start point through the linear change control and changes the duty ratio of the second switching element after the operation mode switching from the second start point through the feedback control, and
the linear change control is control linearly changing a duty ratio.

4. The control device according to claim 3,
wherein the switching power supply circuit or the control device includes:
an input voltage detecting unit detecting the voltage value of the input voltage input between the first upper arm and the first lower arm; and
an output voltage detecting unit detecting the voltage value of the output voltage output between the second upper arm and the second lower arm,
the control device comprises:
an operation mode determining unit determining the operation mode;
a carrier signal generating unit generating a carrier signal of a PWM signal;
a feedback control unit outputting a first signal to be compared with the carrier signal for generating PWM signals in feedback control for a duty ratio in PWM control of the first switching element and feedback control for a duty ratio in PWM control of the second switching element;
a linear change control unit outputting a second signal to be compared with the carrier signal for generating PWM signals in the linear change control for the duty ratio in PWM control of the first switching element and the linear change control for the duty ratio in PWM control of the second switching element;
a first comparison unit generating a PWM signal according to comparison between the first signal and the carrier signal as a A PWM signal;
a second comparison unit generating a PWM signal according to comparison between the second signal and the carrier signal as a B PWM signal; and
a signal switching unit inputting the A PWM signal generated by the first comparison unit to the first switching element as a first PWM signal and inputting the B PWM signal generated by the second comparison unit to the second switching element as a second PWM signal in a case in which the operation mode is determined to be the first mode by the operation mode determining unit, and inputting the B PWM signal generated by the second comparison unit to the first switching element as the first PWM signal and inputting the A PWM signal generated by the first comparison unit to the first switching element as the first PWM signal in a case in which the operation mode is determined to be the second mode by the operation mode determining unit,
the feedback control unit outputs the first signal through feedback control based on the voltage value of the input voltage detected by the input voltage detecting unit, a target value of the voltage value of the input voltage, and the second signal output by the linear change control unit, and
the linear change control unit includes:
a range determining unit determining a range in which the second signal is changed based on the operation mode determined by the operation mode determining unit, the first signal output by the feedback control unit, and the second signal output at the previous time every time the operation mode is switched; and
a counter unit outputting the second signal every time a voltage value of a voltage represented by the second signal is changed with a change rate determined in advance from a start point to an end point of the range determined by the range determining unit.

5. The control device according to claim 4, wherein the operation mode determining unit determines which one of the first mode and the second mode the operation mode is based on the voltage value of the input voltage detected by the input voltage detecting unit and the voltage value of the output voltage detected by the output voltage detecting unit.

6. The control device according to claim 4, wherein the operation mode determining unit determines which one of the first mode and the second mode the operation mode is based on the first signal output from the feedback control unit and the second signal output from the linear change control unit.

7. The control device according to claim 4, wherein the operation mode determining unit determines which one of the first mode and the second mode the operation mode is based on the voltage value of the input voltage detected by the input voltage detecting unit and the voltage value of the output voltage detected by the output voltage detecting unit at the time of a first-time operation of the control device and, thereafter, determines which one of the first mode and the second mode the operation mode is based on the first signal output from the feedback control unit and the second signal output from the linear change control unit.

8. The control device according to claim 4, further comprising a storage unit storing information representing each of the operation mode determined at this time by the operation mode determining unit and the operation mode determined at the previous time by the operation mode determining unit.

9. The control device according to claim 3,
wherein the first mode is a step-down mode, and
the second mode is a step-up/down mode or a step-up mode.

10. The control device according to claim 5, wherein the operation mode determining unit has hysteresis.

11. The control device according to claim 2, wherein a power supply inputting the input voltage between the first upper arm and the first lower arm is a solar panel.

12. A switching power supply circuit comprising a first switching element and a second switching element,
wherein the switching power supply circuit is operated in accordance with an operation mode according to a difference between a voltage value of an input voltage for the switching power supply circuit and a voltage value of an output voltage from the switching power supply circuit,
the switching power supply circuit linearly changes a duty ratio in PWM (Pulse Width Modulation) control of the first switching element from a first start point, and linearly changes a duty ratio in PWM control of the second switching element from a second start point, in a case in which the operation mode operating the switching power supply circuit is to be switched,
the first start point is a duty ratio in PWM control of the first switching element before the operation mode switching set as a start point at which a duty ratio in PWM control of the first switching element after the operation mode switching to be changed,
the second start point is a duty ratio in PWM control of the second switching element before the operation mode switching set as the second start point at which a duty ratio in PWM control of the second switching element after the operation mode switching starts to be changed.

13. A control method controlling a switching power supply circuit including a first switching element and a second switching element, the control method comprising:
operating the switching power supply circuit in accordance with an operation mode according to a difference between a voltage value of an input voltage for the switching power supply circuit and a voltage value of an output voltage from the switching power supply circuit; and
linearly changing a duty ratio in PWM (Pulse Width Modulation) control of the first switching element from a first start point, and linearly changing a duty ratio in PWM control of the second switching element from a second start point, in a case in which the operation mode operating the switching power supply circuit is to be switched,
the first start point is a duty ratio in PWM control of the first switching element before the operation mode switching set as a start point at which a duty ratio in PWM control of the first switching element after the operation mode switching to be changed,
the second start point is a duty ratio in PWM control of the second switching element before the operation mode switching set as the second start point at which a duty ratio in PWM control of the second switching element after the operation mode switching starts to be changed.
